(19) United States
(12) Patent Application Publication
(10) Pub. No.: US 2026/0228583 A1
(43) Pub. Date: Aug. 6, 2026

(54) A COMPUTER-IMPLEMENTED METHOD FOR DETERMINING A CONTROL SEQUENCE FOR PERFORMING A SERIES OF QUBIT INTERACTIONS TO SIMULATE A FERMIONIC HAMILTONIAN, A COMPUTER PROGRAM PRODUCT, A QUANTUM CIRCUIT, AND A METHOD FOR DETERMINING A CHARACTERISTIC OF A SYSTEM

(71) Applicant: IQM FINLAND OY, Espoo (FI)

(72) Inventors: Fedor ŠIMKOVIC, München (DE); Manuel GARCÍA PÉREZ DE ALGABA, München (DE); Martin LEIB, München (DE); Pallasena Viswanathan SRILUCKSHMY, München (DE)

(21) Appl. No.: 19/152,701

(22) PCT Filed: Feb. 2, 2023
(86) PCT No.: PCT/FI2023/050066

§ 371 Date: Jul. 31, 2025

(51) Int. Cl. G06N 10/20; G06N 10/40

(52) U.S. Cl. CPC G06N 10/20; G06N 10/40

(57) ABSTRACT

A computer-implemented method for determining a control sequence for performing qubit interactions on a plurality of qubits on a quantum device with a square qubit layout to simulate a fermionic Hamiltonian, wherein the method comprises receiving input parameters of the fermionic Hamiltonian to be simulated, projecting the associated fermionic lattice to the qubit layout by such that qubits assigned with fermionic modes are termed physical qubits P and qubits not assigned with any fermionic mode are termed ancilla qubits A, wherein the arrangement of physical qubits P and ancilla qubits A in each single horizontal line of the qubit layout is the same.

### TECHNICAL FIELD OF THE INVENTION

The invention relates to quantum devices in general. More specifically, the invention relates to fermionic Hamiltonians and enabling their simulation on quantum devices.

### BACKGROUND OF THE INVENTION

A quantum computer or quantum device is a machine that uses the properties of quantum physics to store data and perform computations. In comparison to a classical computer, which encodes information in the form of bits, e.g. 0s or 1s, a quantum computer uses quantum bits, named qubits, which can be in a coherent superposition of two states simultaneously. A qubit may refer to a basic unit of quantum information or to a quantum device, such as a two-level quantum-mechanical system, used to store a unit of quantum information. A quantum computer will thus generally comprise an array of qubits and hardware to manipulate these qubits.

There are three basic quantum computing methods: analog quantum model, universal quantum gate model, also known as digital quantum computing model or quantum circuit model, and quantum annealing. In the quantum gate model, manipulation of qubits or interaction between qubits is referred to as a gate, where a sequence of one or more gates arranged to be applied to qubits constitutes control sequence for the quantum device which may be referred to as a quantum circuit, which corresponds to instructions for manipulating the units of quantum information in order to perform a desired computation. Quantum gates can further be referred to as unitary operators represented by unitary matrices. Quantum gates acting on a plurality of qubits can further be referred to as an interaction between the plurality of qubits. Implementing a gate acting on a plurality of qubits on a quantum device corresponds to performing qubit interactions on the plurality of qubits.

Hamiltonian equations can be used to study the properties of a quantum many-body system, whereby for instance the electronic structure of a molecule may be determined. As the complexity of classical simulations of quantum many-body systems typically grows exponentially with the dimension of the system, quantum computers can provide powerful tools for simulating many-body problems through implementation of an associated Hamiltonian by simulation of the system interactions through qubit interactions.

While quantum computers are well suited for simulation of quantum many-body systems, current quantum computers are limited by the number of qubits available as well as errors in the form of noise, faults, and loss of quantum coherence. Accuracy of quantum computation results may decrease rapidly as the number of gate operations and circuit depth increase.

Studies of physical fermionic quantum systems which can be characterized by fermionic Hamiltonians are important in many fields of technologies, such as study of superconductivity, battery design, chemical reaction optimization, fertilizers, and novel drugs. When implementing the Hamiltonian, its operations shall be mapped to unitary matrices that can be implemented on a quantum computer. Fermionic quantum systems cannot be straightforwardly simulated utilizing a quantum computer due to the incompatibility of commutation relations between fermionic operations and Pauli operators, which are the unitary matrices considered in relation to qubit interactions.

To be able to efficiently simulate fermionic Hamiltonians on quantum devices, a fermion-to-qubit mapping may be utilized, indicating how modes of the fermionic system are represented in terms of qubits and quantum gates. Many types of fermion-to-qubit mappings exist, yet they may be non-optimal in connection with specific types of hardware and/or specific types of Hamiltonians considered.

### SUMMARY OF THE INVENTION

An object of the invention is to alleviate at least some of the problems of the prior art. In accordance with one aspect of the present invention a method for determining a control sequence for performing a series of qubit interactions on a plurality of qubits on a quantum device to simulate a fermionic Hamiltonian H expressible as a sum of one or more tensor products of Pauli matrices is provided,

wherein the quantum device comprises a plurality of qubits arranged into a two-dimensional square lattice qubit layout, where each qubit is arranged to interact with up to four neighboring qubits, and
wherein the method comprises:
receiving parameters of the fermionic Hamiltonian, the parameters comprising at least:
   a number of fermionic lattice sites L,
   a number of fermionic modes M in the fermionic lattice, and
   fermionic operators corresponding to interactions between the fermionic modes M,
projecting the fermionic lattice to the qubit layout of the quantum device, such that every fermionic mode is assigned to a qubit of the quantum device, wherein said qubit is referred to as a physical qubit P and the projection between the fermionic modes and the physical qubits is one to one, and wherein a plurality of further qubits of the quantum device are referred to as ancilla qubits A, said ancilla qubits A not being assigned with any fermionic mode,
wherein the physical qubits P and ancilla qubits A are arranged onto horizontal single lines of the two-dimensional square lattice, each horizontal single line comprising at least one string P′ and at least one ancilla qubit A, wherein each string P′ comprises one or more physical qubits P,
wherein the arrangement of physical qubits P and ancilla qubits A in each horizontal single line of the qubit layout is the same,
associating each physical qubit P with at least one edge operator E and one vertex operator V,
mapping each fermionic operator to a qubit operator based on the edge operators E and vertex operators V,
determining a control sequence of qubit interactions, said control sequence comprising at least the qubit operators determined by the mapping.

The invention may provide a fermion-to-qubit mapping that is well suitable or optimal for use in solving problems involving a range of different considered fermionic systems and/or Hamiltonians. Optimal or well suitable may mean that the method of the invention may be used to provide mappings for various use cases without having to tailor mappings for each case separately, which requires more (human) labor. Optimal or well suitable may additionally or alternatively mean that the method of the invention may provide a fermion-to-qubit mapping that is of high quality when considering one or more aspects related to performance when carrying out calculations or simulations on a quantum device based on the determined mappings.

The present invention may provide fermion-to-qubit mappings that are well-suited for use in connection with square lattice qubit layouts of quantum devices. Being well-suited for a specific qubit layout may refer to a possibility of utilizing a number of qubits available to a higher degree or more efficiently than in corresponding prior art cases.

The mappings according to embodiments of the invention may provide control sequences that correspond to quantum circuits that are lower in depth than quantum circuits obtained with prior art mappings for the same problem or simulation (the characteristic determined for a specific fermionic system with a selected fermionic Hamiltonian considered). Computational time required may then be reduced, thus mitigating errors and/or saving energy, for instance. In some embodiments, the circuit depth may be utilized as a primary optimization criterion to obtain maximally reduced (shortest) circuit depths.

In some embodiments, the present invention may provide fermion-to-qubit mappings that result in constant circuit depth. The constant circuit depth may result from having edge and vertex operators that do not scale with system size in terms of the number of fermionic lattice sites of the fermionic Hamiltonian. This may be true at least for two-dimensional fermionic lattices.

In some embodiments a circuit depth may scale linearly with the considered number of fermionic modes per fermionic lattice site. Yet, considered qubit operators may comprise a maximum of 4 Pauli weight, independent of the size of the considered fermionic system. In contrast, for example with the Jordan-Wigner mapping known from the prior art, at least some of the considered qubit operators will scale with N in the case of a fermionic square lattice of size N².

With each line of the qubit layout being the same (in terms of arrangement of physical qubits and ancilla qubits), edge operators may be obtained that connect two physical qubits through a vertical stack of ancilla qubits. This arrangement may reduce the depth of quantum circuits obtained through the determined control sequences.

Each qubit operator may comprise a product of vertex operators V, where each of the vertex operator in the product operates on at least one of the physical qubits P assigned with the fermionic modes of the fermionic operator.

Each qubit operator may comprise a product of at least one of the vertex operators V and one of the edge operators E, where each of the vertex and edge operators in the product operates on at least one of the physical qubits P assigned with the fermionic modes of the fermionic operator.

Associating each physical qubit P with at least one edge operator E and one vertex operator V may comprise determining edge operators E and vertex operators V such that edge and vertex operators acting on the same physical qubits pairwise anticommute and all other operator pairs commute.

Associating each physical qubit P with at least one edge operator E and one vertex operator V may in some embodiments comprise:
associating each physical qubit P with a vertex operator Vₚ, wherein Vₚ is a Pauli operator of first type, selected from Pauli operator types X, Y and Z, acting on physical qubit p,
for any pair of physical qubits p and q, which in the horizontal dimension are either direct neighbors without any physical or ancilla qubits between them, or are separated by one or two ancilla qubits, define a horizontal edge operator

$${E}_{pq}^{H} ,$$

associated with said qubits, wherein

$${E}_{pq}^{H}$$

is a product of a number of Pauli operators comprising:
at least two Pauli operators, each of second or third type, selected from Pauli operator types X, Y, and Z, and acting on qubits p and q respectively, and
if any ancilla qubits are present between the physical qubits p and q along the horizontal dimension, additional Pauli operators, each of first type, acting on each of said, if any present, ancilla qubits,
wherein when two horizontal edge operators act on the same qubit q, if the first of the two horizontal edge operators

$${E}_{pq}^{H 1}$$

acts on the qubit q with a Pauli operator of second type, then the second of the two horizontal edge operators

$${E}_{pq}^{H 2}$$

acts on the qubit q with a Pauli operator of third type and vice versa,
for any pair of physical qubits p and q, which in the vertical dimension are direct neighbors without any physical or ancilla qubits between them, and where said pair of qubits is adjacent to a pair of ancilla qubits a and b, where said ancilla qubits a and b are direct neighbors in the vertical dimension, arranged adjacent to the qubits p and q respectively, define a vertical edge operator

$${E}_{pq}^{V} ,$$

associated with said qubits p, q, a, b, wherein

$${E}_{pq}^{V}$$

is a product of four Pauli operators, each of second or third type and each acting on one of the qubits p, q, a, b such that each of the four Pauli operators acts on a different qubit, wherein
   the Pauli operators acting on the ancilla qubits a and b are of different type,
   the Pauli operator acting on the physical qubit p is of the same type as the Pauli operator acting on the physical qubit q and forming a part of the horizontal edge operator acting on at least the physical qubit p and the ancilla qubit a, and similarly the Pauli operator acting on the physical qubit q is of the same type as the Pauli operator acting on the physical qubit p and forming a part of the horizontal edge operator acting at least on the physical qubit q and the ancilla qubit b,
   a vertical edge operator is referred to as a first vertical edge operator

$${E}_{pq}^{V 1}$$

when the ancilla qubits a and b are arranged on a first side of the physical qubits p and q respectively along the horizontal dimension, or as a second vertical edge operator

$${E}_{pq}^{V 2}$$

when the ancilla qubits a and b are arranged on a second side of the physical qubits p and q along the horizontal dimension,
   wherein when two vertical edge operators act on the same ancilla qubit, if one of the two vertical edge operators acts on said ancilla qubit with a Pauli operator of second type, then the other of the two vertical edge operators acts on said ancilla qubit with a Pauli operator of third type and vice versa.

Preferably, in a row of qubits, there are at most two consecutive ancilla qubits A. More may be utilized, but a maximum of two consecutive ancilla qubits may be more efficient.

Receiving parameters of the fermionic Hamiltonian to be simulated may additionally comprise obtaining a number of fermionic modes in each of the fermionic lattice sites, a number of fermionic lattice sites in a first dimension L₁, a number of fermionic lattice sites in a second dimension L₂, and a number of fermionic lattice sites in a third dimension L₃, where a total number of fermionic lattice sites is L=L₁L₂L₃, a fermionic lattice site can be identified by indices i, j, k, indicating fermionic lattice site position along the respective dimensions, where i=[1, L₁], j=[1, L₂], k=[1, L₃], and the number of fermionic modes in each of the fermionic lattice sites identified by indices i, j, k can be labelled as Mᵢⱼₖ such that total number of fermionic modes in the fermionic lattice is

$$M = {\sum }_{i = 1}^{{L}_{1}} {\sum }_{j = 1}^{{L}_{2}} {\sum }_{k = 1}^{{L}_{3}} {M}_{ijk}$$

and wherein each fermionic mode of the fermionic Hamiltonian can be identified by four indices i, j, k, l, where l=[1, Mᵢⱼₖ]. The step of projecting the fermionic lattice onto the square lattice qubit layout of the quantum device may then further comprise assigning each fermionic mode, identified by the four indices i, j, k, l, of the fermionic lattice to a physical qubit Pᵢⱼₖₗ of the quantum device, where the indices of each physical qubit identify the fermionic mode with which the physical qubit is assigned.

The step of projecting the fermionic lattice onto the qubit layout of the quantum device may then also comprise arranging the physical qubits Pᵢⱼₖₗ, each assigned with a fermionic mode identified by the indices i, j, k, l, within the qubit layout such that:
each horizontal single line of the qubit layout comprises L₁ strings P′, each string denoted as P′ᵢⱼ to indicate that the string comprises a number of physical qubits Pᵢⱼₖₗ assigned with fermionic modes associated with fermionic lattice sites with position indices i and j, where the number of physical qubits within a string P′ᵢⱼ is equal to

$${\sum }_{k = 1}^{{L}_{3}} {M}_{ijk} ,$$

each physical qubit with a lower index i is arranged, in the horizontal dimension, before any physical qubit with a higher index i,
the number of horizontal single lines in the qubit layout that is participating in the projecting is equivalent to L₂, and each physical qubit with a lower index j is arranged, in the vertical dimension, before any physical qubit with a higher index j, and
physical qubits within each string P′ are associated with varying indices k and l and arranging their respective order depending on the fermionic interactions.

Physical qubits within any string P′ in the horizontal dimension may be arranged such that the order of physical qubits with indices k and l is opposite in the consecutive string P′.

If one or more of the fermionic lattice sites comprises more than one mode associated with said lattice site, the control sequence may further comprise one or more fSWAP operators to rearrange fermionic modes assigned to physical qubits by the projecting, to implement interactions between fermionic modes that are comprised in the Hamiltonian, for which interactions a qubit operator has not been applied before said rearranging.

If the fermionic Hamiltonian describes a system with two or more spin types within a fermionic lattice site, the modes Mᵢⱼₖ per each fermionic lattice site may be further assigned into a number of orbitals o, each orbital comprising a number of spins s, where Mᵢⱼₖ=0*s, where the physical qubits assigned with fermionic modes with the spins of one orbital are each separated by one physical qubit and where if the l indices of the physical qubits assigned with an orbital are odd, the fermionic modes associated with the physical qubits with the indices l are arranged so that increasing index l is associated with an increasing spin type s, whereas if the l indices of the physical qubits representing an orbital are even, the fermionic modes associated with the physical qubits with indices l may be arranged so that increasing index/is associated with a decreasing spin type s.

The associating of physical qubits with edge and vertex operators may take into account native gates of the quantum device at which the obtained control sequence is to be implemented. In one embodiment, the physical qubits in a row of qubits in the horizontal dimension may be grouped into pairs of physical qubits alternatingly labelled as even or odd, wherein ancilla qubits are not considered, and neighboring even and odd pairs share a physical qubit, wherein the associating each physical qubit with at least one edge operator may then comprise:
for each even pair of physical qubits p and q and the one or more ancilla qubits between them if present, define an even horizontal edge operator

$${E}_{pq}^{H 1}$$

associated with said qubits, wherein
   if p and q are direct neighbors not separated by an ancilla qubit,

$${E}_{pq}^{H 1}$$

is a product of two Pauli operators of second type acting on physical qubits p and q, respectively, optionally wherein

$${E}_{pq}^{H 1} = {X}_{p} {X}_{q}$$

if p and q are separated by one ancilla qubit a,

$${E}_{pq}^{H 1}$$

is a product of a Pauli operator of second type acting on physical qubit p, a Pauli operator of first type acting on ancilla qubit a, and a Pauli operator of second type acting on physical qubit p, optionally wherein

$${E}_{pq}^{H 1} = {X}_{p} {Z}_{a} {X}_{q} ,$$

if p and q are separated by two ancilla qubits a and b,

$${E}_{pq}^{H 1}$$

is a product of a Pauli operator of second type acting on physical qubit p, a Pauli operator of first type acting on ancilla qubit a, a Pauli operator of first type acting on ancilla qubit b, and a Pauli operator of second type acting on physical qubit p, optionally wherein

$${E}_{pq}^{H 1} = {X}_{p} {Z}_{a} {Z}_{b} {X}_{q} ,$$

for each pair of odd physical qubits p and q and the one or more ancilla qubits between them if present, define an odd horizontal edge operator

$${E}_{pq}^{H 2}$$

associated with said qubits, wherein
   if p and q are direct neighbors not separated by an ancilla qubit,

$${E}_{pq}^{H 2}$$

is a product of two Pauli operators of third type acting on physical qubits p and q, respectively, optionally wherein

$${E}_{pq}^{H 2} = {Y}_{p} {Y}_{q} ,$$

if p and q are separated by one ancilla qubit a,

$${E}_{pq}^{H 2}$$

is a product of a Pauli operator of third type acting on physical qubit p, a Pauli operator of first type acting on ancilla qubit a, and a Pauli operator of third type acting on physical qubit p, optionally wherein

$${E}_{pq}^{H 2} = {Y}_{p} {Z}_{a} {Y}_{q} ,$$

if p and q are separated by two ancilla qubits a and b,

$${E}_{pq}^{H 2}$$

is a product of a Pauli operator of third type acting on physical qubit p, a Pauli operator of first type acting on ancilla qubit a, a Pauli operator of first type acting on ancilla qubit b, and a Pauli operator of third type acting on physical qubit p, optionally wherein

$${E}_{pq}^{H 2} = {Y}_{p} {Z}_{a} {Z}_{b} {Y}_{q} ,$$

for each pair of physical qubits p and q, which in the vertical dimension are direct neighbors without any physical or ancilla qubits between them, define a vertical edge operator

$${E}_{pq}^{V}$$

associated with said qubits, wherein
   if ancilla qubits a and b are direct neighbors of p and q in the horizontal dimension in a first direction, with p and q having no other ancilla qubits as direct horizontal neighbors, and wherein a and b are associated with even horizontal edge operators,

$${E}_{pq}^{V}$$

is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein

$${E}_{pq}^{V} = {X}_{p} {X}_{a} {Y}_{b} {X}_{q} ,$$

if ancilla qubits a and b are direct neighbors of p and q in the horizontal dimension in the first direction, with p and q having no other ancilla qubits as direct horizontal neighbors, and wherein a and b are associated with odd horizontal edge operators,

$${E}_{pq}^{V}$$

is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein

$${E}_{pq}^{V} = {Y}_{p} {X}_{a} {Y}_{b} {Y}_{q} ,$$

if ancilla qubits a and b are direct neighbors of p and q in the horizontal dimension in a second direction, with p and q having no other ancilla qubits as direct horizontal neighbors, and wherein a and b are associated with even horizontal edge operators,

$${E}_{pq}^{V}$$

is a product of a Pauli operator of the second type acting on physical qubit p, a Pauli operator of the third type acting on ancilla qubit a, a Pauli operator of the second type acting on ancilla qubit b, and a Pauli operator of the second type acting on physical qubit q, optionally wherein

$${E}_{pq}^{V} = {X}_{p} {Y}_{a} {X}_{b} {X}_{q} ,$$

if ancilla qubits a and b are direct neighbors of p and q in the horizontal dimension in the second direction, with p and q having no other direct ancilla qubits as horizontal neighbors, and wherein a and b are associated with odd horizontal edge operators,

$${E}_{pq}^{V}$$

is a product of a Pauli operator of the third type acting on physical qubit p, a Pauli operator of the third type acting on ancilla qubit a, a Pauli operator of the second type acting on ancilla qubit b, and a Pauli operator of the third type acting on physical qubit q, optionally wherein

$${E}_{pq}^{V} = {Y}_{p} {Y}_{a} {X}_{b} {Y}_{q} ,$$

if p and q are direct neighbors of ancilla qubits a and b in the horizontal dimension in the first direction, with ancilla qubits c and d as direct neighbors in the second direction,
   for the first direction:

$${E}_{pq}^{V}$$

is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein

$${E}_{pq}^{V} = {X}_{p} {X}_{a} {Y}_{b} {X}_{q} , or {E}_{pq}^{V}$$

is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein

$${E}_{pq}^{V} = {Y}_{p} {X}_{a} {Y}_{b} {Y}_{q} ,$$

for the second direction:

$${E}_{pq}^{V}$$

is a product of a Pauli operator of the second type acting on physical qubit p, a Pauli operator of the third type acting on ancilla qubit c, a Pauli operator of the second type acting on ancilla qubit d, and a Pauli operator of the second type acting on physical qubit q, optionally wherein

$${E}_{pq}^{V} = {X}_{p} {Y}_{c} {X}_{d} {X}_{q ,} , or {E}_{pq}^{V}$$

is a product of a Pauli operator of the third type acting on physical qubit p, a Pauli operator of the third type acting on ancilla qubit c, a Pauli operator of the second type acting on ancilla qubit d, and a Pauli operator of the third type acting on physical qubit q, optionally wherein

$${E}_{pq}^{V} = {Y}_{p} {Y}_{c} {X}_{d} {Y}_{q} .$$

Pauli operators of first type, second type, and third type are all different from each other, at least if more than one of these are considered in one edge operator. The selection of which Pauli operator is first, which is second, and which is third may differ. In the above, if

$${E}_{pq}^{V} = {X}_{p} {Y}_{c} {X}_{d} {X}_{q} ,$$

then as given, it may be that

$${E}_{pq}^{V} = {Y}_{p} {Y}_{c} {X}_{d} {Y}_{q}$$

or alternatively,

$${E}_{pq}^{V} = {Y}_{p} {X}_{c} {Y}_{d} {Y}_{q} .$$

Additionally, for instance, the example given above of

$${E}_{pq}^{H 1} = {X}_{p} {Z}_{a} {Z}_{b} {X}_{q}$$

could also be

$${E}_{pq}^{H 1} = {Y}_{p} {Z}_{a} {Z}_{b} {Y}_{q} .$$

Qubits may be grouped into patterns that are repeated in the horizontal dimension, wherein the pattern is selected from the group of P′A, P′P′A, P′P′AA, and P′AA. A selection of pattern may be made based on criteria related to Pauli weights of operators, circuit depth of an associated quantum circuit, and/or types of associated gates. The selected or optimal pattern may be different for e.g. different types of Hamiltonians.

The pattern may be selected by determining maximum Pauli weights of edge operators associated with at least two patterns and selecting a pattern that is associated with a lowest maximum Pauli weight.

The pattern may be selected by determining a circuit depth of a control sequence separately associated with at least two patterns and selecting a pattern that is associated with a lowest circuit depth.

The pattern may be selected by determining a number and/or type of gates comprised in a control sequence separately associated with at least two patterns, and selecting a pattern that is associated with a lowest number of gates and/or a pattern that is associated with selected types of gates, and/or a pattern that is associated with a selected qubit-to-mode ratio.

In an aspect of the invention, a computer program product according to independent claim 17 may be provided. In yet further aspects of the invention, a quantum circuit according to claim 18 and a method for determining at least one characteristic of a system according to claim 19 may be provided.

The expression “a number” may herein refer to any positive integer starting from one (1).

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 shows examples of arrangements of qubits in patterns and rows in the horizontal and vertical dimensions according to embodiments of the invention.

FIG. 2 illustrates some examples of vertex and edge operators.

FIG. 3 shows edge and vertex operators that may be utilized in connection with one exemplary embodiment of the invention.

FIG. 4 shows edge and vertex operators that may be utilized in connection with one further exemplary embodiment of the invention.

FIG. 5 depicts edge and vertex operators associated with one example of a multi-mode fermionic lattice site and an illustration of a related fSWAP network.

FIG. 6 shows some examples of fermionic lattice geometries.

FIG. 7 gives an example of a fermionic lattice and considered connectivity and interaction terms.

FIG. 8 illustrates a qubit hardware layout.

FIG. 9 depicts exemplary hopping operators.

FIG. 10 illustrates an fSWAP network with modes and orbitals of an exemplary fermionic system.

### DETAILED DESCRIPTION

The electronic structure Hamiltonian Hₑₛ may in the second quantization formalism be expressed as

$${H}_{es} = {\sum }_{p , q} {h}_{pq} {c}_{p}^{†} {c}_{q} + {\sum }_{p , q , r , s} {h}_{pqrs} {c}_{p}^{†} {c}_{q}^{†} {c}_{r} {c}_{s} , \qquad ( 1 )$$

where p, q, r, and s may represent different fermionic modes, cᵢ and

$${c}_{i}^{†}$$

are the annihilation and creation operators, respectively, which create and annihilate a fermion on mode i, and h_{pq}, h_{pqrs} represent one-electron and two-electron integrals, respectively, which may be considered as known constants. Quadratic terms (involving two fermionic creation/annihilation operators) in the first sum of the Hamiltonian may be referred to as hopping operators, whilst quartic terms may be referred to as interaction operators.

When characterizing physical systems for which the Hamiltonian equation is to be solved or which are to be simulated, a Hamiltonian may be considered where selected terms, connectivity, and/or spins are taken into account, leading to Hamiltonians that are sparser, i.e. less dense (meaning a lower amount of fermionic operators involved) than the electronic structure Hamiltonian Hₑₛ above, which has an order of O(M⁴) terms, where M is the total number of fermionic modes considered. One example of a sparse Hamiltonian comes from the Fermi-Hubbard model, which may be used in condensed-matter physics. Here, the Hamiltonian, where the number of terms have the order of O(M²), is:

$${H}_{FHM} = - t {\sum }_{p , q} {c}_{p}^{†} {c}_{q} + U {\sum }_{pq} {c}_{p}^{†} {c}_{q}^{†} {c}_{p} {c}_{q} , \qquad ( 2 )$$

where t and U can be considered as constants. Hamiltonians that are to be considered may vary in terms of the total number of fermionic operators (denseness/sparsity). Typically, e.g. Hamiltonians considered relating to problems in quantum chemistry may be denser than e.g. the Fermi-Hubbard Hamiltonian H_{FHM}.

As fermions are particles with half-integer spins that obey the Pauli exclusion principle, only one fermion can occupy a specific quantum state at a given time. Thus, a quantum state should be antisymmetric under exchange, and the annihilation and creation operators should anti-commute, such that:

$$\{ {c}_{p}^{†} , {c}_{q} \} = {δ}_{pq} , \qquad ( 3 )$$

$$\{ {c}_{p}^{†} , {c}_{q}^{†} \} = 0 , and \qquad ( 4 )$$

$$\{ {c}_{p} , {c}_{q} \} = 0. \qquad ( 5 )$$

Yet, the Pauli spin operators σᵢ, and also tensor products thereof, which are regularly used as quantum gates in quantum computers to perform qubit operations and which may be used to simulate Hamiltonians on quantum devices, anti-commute, such that

$$\{ {σ}_{p} , {σ}_{q} \} = 2 {δ}_{pq} I , \qquad ( 6 )$$

where σᵢ∈[X, Y, Z] and:

$$I = ( \begin{matrix}1 & 0 \\ 0 & 1\end{matrix} ) , \qquad ( 7 )$$

$$X = ( \begin{matrix}0 & 1 \\ 1 & 0\end{matrix} ) , \qquad ( 8 )$$

$$Y = ( \begin{matrix}0 & - i \\ i & 0\end{matrix} ) , \qquad ( 9 )$$

$$and$$

$$Z = ( \begin{matrix}1 & 0 \\ 0 & - 1\end{matrix} ) . \qquad ( 10 )$$

A mapping between Hilbert spaces of a fermionic system and a collection of qubits of a quantum device may enable the representation of the fermionic system on the device. A fermion-to-qubit mapping (also called “mapping” herein) may map fermionic operators to strings of Pauli operators, which may be implemented as a quantum circuit to induce qubit interactions on a quantum device to simulate the fermionic interactions of the Hamiltonian, while preserving fermionic parity (meaning that the qubit interaction representation should comprise an equal number of interactions corresponding to creation and annihilation operators, respectively, as does the fermionic Hamiltonian). The fermionic interactions may here refer to interaction involving both interaction and hopping operators.

A fermionic Hamiltonian may then be rewritten or expressed in the form:

$$H = {\sum }_{f = 1}^{F} {a}_{j} {⊗}_{n = 1}^{N} {\tilde{σ}}_{n}^{f} \qquad ( 11 )$$

Where the product is a tensor product, aⱼ are coupling constants, the index f runs over all F operators comprised in the fermionic Hamiltonian, the index n runs over the total number of qubits in the device N, anu

$${\tilde{σ}}_{n}^{f} ∈ [ I , X , Y , Z ] .$$

A Pauli weight associated with the Hamiltonian may be determined as a maximum Pauli weight of any of the addends.

Further properties of the Hamiltonians that characterize the system they relate to are e.g. the fermionic lattice dimension and number of lattice sites (L=LₓL_{y}L_{z}, where Lₓ is the number of lattice sites in a first dimension, L_{y} is the number of lattice sites in a second dimension, and L_{z} is the number of lattice sites in a third dimension), the total number of fermionic modes (M) and the number of modes per lattice site (M/L).

Hamiltonians may range widely in terms of the degree of connectivity, i.e. which interactions between fermions are to be considered. The connectivity can include only nearest-neighbor interactions, nearest-neighbor interactions and next-nearest-neighbor interactions, or nearest-neighbor interactions, next-nearest-neighbor interactions, and higher-neighbor interactions).

Considered sites (single qubits) on a qubit layout may be assigned to represent modes of a considered Hamiltonian. A fermion-to-qubit mapping may be carried out by first defining edge (E_{pq}=−E_{qp}) and vertex (Vₚ) operators that generate a qubit connectivity graph comprising commutation relations corresponding to those of fermions. After defining such edge and vertex operators, any fermionic operator may be translated into a product of edge and vertex operators, which can then be expressed in terms of operators acting on qubits. The edge and vertex operators may be defined as:

$${E}_{pq} = - i ( {c}_{p}^{†} + {c}_{p} ) ( {c}_{q}^{†} + {c}_{q} ) \qquad ( 12 )$$

$$and$$

$${V}_{p} = - ( {c}_{p}^{†} + {c}_{p} ) ( {c}_{p}^{†} - {c}_{p} ) . \qquad ( 13 )$$

One may further show that the edge and vertex operators obey the anticommutation relations:

$$\{ {E}_{pq} , {V}_{p} \} = 0 \qquad ( 14 )$$

$$and$$

$$\{ {E}_{pq} , {E}_{qr} \} = 0 , \qquad ( 15 )$$

further wherein the operators obey the following commutation relations ([A, B]=AB−BA), and anticommutation relations ([A, B]=AB+BA):

$$[ {E}_{pq} , {E}_{rs} ] = 0 , \qquad ( 16 )$$

$$[ {V}_{p} , {V}_{q} ] = 0 , \qquad ( 17 )$$

$$and$$

$$[ {E}_{pq} , {V}_{r} ] = 0 \qquad ( 18 )$$

$$for p \neq q \neq r \neq s .$$

These relations may be summed up by stating that any two distinct vertex or edge operators mutually anti-commute if they are acting on a common fermionic mode and commute otherwise. Finding a suitable fermion-to-qubit mapping may then comprise determining strings of Pauli operators to correspond to the vertex and edge operators to satisfy the relations above. A Pauli weight associated with a mapping may be determined as a maximum Pauli weight associated with any of the edge or vertex operator. A Pauli weight may refer to a number of different qubits that are associated with the operators that are utilized.

A further condition that shall be considered is that products of edge operators on closed paths {p₁, p₂, . . . }, i.e. edge operators that connect qubits to form a closed path, such as E₁₂, E₂₃, and E₃₁, should be equal to identity:

$${i}^{( \vert p \vert - 1 )} = {\prod }_{j}^{\vert p \vert - 1} {E}_{{p}_{j} , {p}_{j + 1}} = \text{?} \qquad ( 19 )$$

Regarding the above condition, an initial state may be selected such that it is in the +1 eigenspace of the product of edge operators over all the closed paths. As long as this condition on the initial state is satisfied, equation 19 does not have to be considered when constructing mappings.

Suitable edge and vertex operators may be determined by for instance determining a plurality of different combinations (such as all possible combinations) of tensor products of Pauli operators and selecting a set of operators that satisfy selected criteria, such as at least the anticommutation and commutation criteria.

After determining a set of suitable edge and vertex operators, these may be utilized in mapping each interaction between fermionic modes to a qubit operator and find expressions corresponding to the fermionic operators of a considered problem Hamiltonian.

To determine a set of qubit interactions that correspond to the interactions between fermionic modes, relationships between edge and vertex operators, fermionic Majorana operators γᵢ γ̅ᵢ and the fermionic annihilation and creation operators may be utilized. Such relationships are given by:

$${V}_{p} = - i ( {γ}_{p} {\overline{γ}}_{p} ) \qquad ( 20 )$$

$${E}_{pq} = - i ( {γ}_{p} {γ}_{q} ) \qquad ( 21 )$$

$${γ}_{p} = ( {c}_{p} + {c}_{p}^{†} ) \qquad ( 22 )$$

$${\overline{γ}}_{p} = \frac{1}{i} ( {c}_{p} - {c}_{p}^{†} ) \qquad ( 23 )$$

By using commutation properties of these edge, vertex, Majorana, and annihilation and creation operators, expressions for the different fermionic interactions that are required for each use case may be determined. Some examples may be given as:

$${c}_{p}^{†} {c}_{q} \to \frac{i}{4} ( 1 + {V}_{q} - {V}_{p} - {V}_{p} {V}_{q} ) {E}_{pq} , \qquad ( 24 )$$

$${c}_{p}^{†} {c}_{q}^{†} {c}_{r} {c}_{s} \to \frac{1}{16} ( 1 + {V}_{s} - {V}_{q} - {V}_{r} {V}_{s} + {V}_{r} - {V}_{p} + {V}_{r} {V}_{s} + {V}_{p} {V}_{q} - {V}_{q} {V}_{r} - {V}_{p} {V}_{r} - {V}_{p} {V}_{s} - {V}_{q} {V}_{r} {V}_{s} + {V}_{p} {V}_{q} {V}_{s} - {V}_{p} {V}_{r} {V}_{s} + {V}_{p} {V}_{q} {V}_{r} + {V}_{p} {V}_{q} {V}_{r} {V}_{s} ) {E}_{pq} {E}_{rs} , \qquad ( 25 )$$

$${c}_{p}^{†} {c}_{q} + {c}_{q}^{†} {c}_{p} \to \frac{i}{2} ( {V}_{q} - {V}_{p} ) {E}_{pq} , \qquad ( 26 )$$

$$and$$

$${c}_{p}^{†} {c}_{q}^{†} {c}_{r} {c}_{s} + {c}_{p}^{†} {c}_{r}^{†} {c}_{q} {c}_{s} + {c}_{r}^{†} {c}_{s}^{†} {c}_{p} {c}_{q} + {c}_{s}^{†} {c}_{q}^{†} {c}_{r} {c}_{p} \to \frac{1}{4} ( {V}_{p} {V}_{q} - {V}_{p} {V}_{r} + {V}_{r} {V}_{s} - {V}_{s} {V}_{q} ) {E}_{pr} {E}_{qs} . \qquad ( 27 )$$

A consideration that may be used in the determination of a mapping is that not all possible edges, i.e. not all possible connectivities between fermionic modes, are required to be directly represented in the connectivity graph. It may suffice that the qubit sites corresponding to an any edge are connected by a path comprising of intermediate edge operators, to form a “composite” edge operator, as:

$${E}_{pr} = {E}_{pq} {E}_{qr} . \qquad ( 28 )$$

Yet, it is also possible to dynamically alter the connectivity graph itself by using fermionic swap (fSWAP) operations, which exchange the position of two fermionic modes which are connected by an edge. Such an fSWAP operator is defined as:

$${fSWAP}_{pq} = {e}^{\frac{i π}{4} {V}_{p}} {e}^{\frac{i π}{4} {V}_{q}} {e}^{\frac{π}{4} {V}_{p} {E}_{pq}} {e}^{\frac{π}{4} {E}_{pq} {V}_{q}} \qquad ( 29 )$$

Through an fSWAP operator, modes of the Hamiltonian which interact with each other may be brought closer together, thus reducing the Pauli weights of the corresponding Hamiltonian operators. However, it may be taken into account that this comes at the cost of having to implement the fSWAP operations themselves, which may increase the computational effort.

There are various considerations or criteria that may be taken into account in the selection of the edge and vertex operators and thus the determination of the fermion-to-qubit mapping. The favoring of some criterion or criteria may lead to weaknesses relating to other aspects. Criteria may be related to performance aspects in terms of computational resources required to carry out a simulation/calculation on a quantum device utilizing the determined mapping and a control sequence determined therefrom (e.g. circuit depth, number of two-qubit gates, qubit-to-mode ratio i.e. how many qubits are required to encode one fermionic mode, and/or Pauli weights), limitations imposed by hardware aspects (such as a number of qubits and/or connectivity of a qubit layout that is to be utilized and/or types of one- and/or two-qubit gates allowed, depending on which gates are native to the hardware in question), error-related aspects relating to known or estimated errors or requirements for error correction relating to the calculations performed via the quantum device, and/or versatility aspects relating to the types of Hamiltonians the mapping may be applied to. Therefore, it may not be possible to determine a fermion-to-qubit mapping that is optimal in performance in connection with any type of Hamiltonian, any type of fermionic system, and any type of hardware.

Many known mappings, such as the Jordan-Wigner transformation, are not local or constant-depth, such that the Pauli weight of the associated edge and/or vertex operators does not stay constant as the size of the fermionic system is increased. This may be a disadvantage, as the computational load then increases with increasing system size. In the Jordan-Wigner mapping a fermionic mode is mapped to a single qubit and all fermionic vertex operators are mapped to single-qubit operators. All the fermionic modes are arranged on a linear chain and nearest-neighbors (NN) on this connectivity graph are connected by a fermionic edge operator, which translates into a two-qubit operator. In this mapping, for non-NN fermionic modes which interact, the Pauli weight of the qubit operators scales with their distance on the chain, which in the worst (all-to-all) case thus scales with the system size.

Improved scalability with system size has been considered in prior art mappings that utilize fSWAP operations as fSWAP networks in connection with the Jordan-Wigner mapping, but to bring all two-mode-pairs together in the mapping, these methods require circuit depths that are not optimal in many use cases.

A known alternative approach to the Jordan-Wigner mapping involves the use of ancilla qubits to “fix” fermionic commutation relations and allow for fermionic connectivity graphs that are higher than one-dimensional. The ancilla qubits may be qubits that are not associated with any fermionic modes (not associated with a vertex operator). Here, the operator weights are constant with respect to the fermionic system size, but a problem with such known mappings are that they are tailored to specific fermionic lattices and are not easily generalizable to Hamiltonians in dimension higher than two and/or with a high degree of connectivity, such as over 8. These known mappings may be tailored case-by-case and may be suitable to simulate e.g. condensed matter physics systems such as the Fermi-Hubbard model.

Yet, the prior art does not present a strategy that could be used to obtain an optimal or feasible mapping involving a range of different types of fermionic systems and associated Hamiltonians. The present invention may provide such mappings.

The present invention aims at providing a fermion-to-qubit mapping that is well adapted for use on hardware comprising a square lattice qubit layout, where one qubit is connectable with at most four other qubits. Prior art mappings have not been designed or optimized specifically for square qubit layouts. However, a square qubit layout is one that is technically feasible and may be realistically provided by current hardware providers.

Further considerations taken into account by the present invention are providing mappings which have low-weight composite edge operators for further-neighbor (over NN) edges, enabling simulation of e.g. a broad class of two-dimensional fermionic lattices from condensed matter physics.

Yet, the mappings described herein may provide a lower Pauli weight than prior art mappings, and/or a mapping wherein the Pauli weights are independent on the fermionic lattice dimensions and/or the number of modes per fermionic lattice site.

An optimality of the mapping for selected use cases considering specific types of Hamiltonians and/or fermionic systems and/or specific type of hardware, or providing a mapping taking into account such criteria, has not been considered previously in the prior art.

In more detail, the mappings considered herein may be determined in relation to the following criteria:
qubits can preferably only interact (via two-qubit gates) with up to four neighbors on a square qubit lattice connectivity graph,
all vertex and edge operators should have a Pauli weight which is constant in the total number of fermionic lattice sites as well as the number of modes per lattice site M/L, wherein the Pauli weight is preferably as low as possible or at least lower than that considered in some prior art mappings,
a number of fSWAPs used may preferably be constant in two dimensions (such as Lₓ and L_{y}), and is preferably allowed to scale linearly with the number of fermionic modes per fermionic lattice site and the third dimension, and/or
the mapping should preferably be universal at least to a selected degree, such that the mapping may produce (near-) optimal results when applied to at least a selected amount of different fermionic systems in terms of number of considered fermionic lattice sites, number of fermionic modes, and/or number of fermionic operator terms (sparseness/density).

When a mapping involves edge and vertex operators that have been selected to provide low or optimized Pauli weights, a resulting quantum circuit may be provided that also has low or optimized circuit depth, as circuit depth may be strongly related to the Pauli weights of operators. A depth of a quantum circuit may refer to the number of time steps required for its completion. Therefore, reduction of circuit depth may result, in addition to reduced computation time, reduced errors, as quantum computations may involve increased error as the time required for computation is increased. In connection with noisy intermediate-scale quantum (NISQ) era devices, reduction of circuit depth may be important due to low fidelities. Circuit depths provided by the present invention may be advantageous, with circuit depth being counted in the number of native two-qubit gates per Trotter layer.

With the number of fSWAPS being constant in two dimensions and being allowed to scale linearly with the number of fermionic modes per site and the third dimension, the number of fSWAPs utilized may grow as O(L_{z}M/L). This may also ensure that a circuit depth grows less with system size than in the prior art.

When a fermion-to-qubit mapping is usable with a selection of different types of fermionic systems, this may reduce the otherwise possibly significant overhead in human labor due to investigating mappings for different fermionic models on a case-by-case basis.

While many prior art mappings have been determined in view of optimizing for low qubit-to-mode ratios, these may result in circuit depths that are non-advantageous. The mappings determined through the present invention may be determined to optimize or consider a lower or lowest possible circuit depth as a more important optimization criterion than qubit-to-mode ratio, which may be considered as a secondary optimization criterion.

The invention may be carried out by one first computing device or processor or a plurality of computing devices. The determination of a mapping and/or determination of an associated control sequence may be carried out by a first computing device comprising a classical computer or processor. The first computing device may receive one or more inputs e.g. being provided by a user of the first computing device or by another computing program determining the input(s) based on additional information provided by the user, where the additional information could be, e.g., properties describing the quantum device (such as number of qubits to be utilized and/or information regarding native gates) on which a specific fermionic system is to be implemented and/or desired properties of the fermionic system or associated Hamiltonian. Any inputs may additionally or alternatively be obtained e.g. via a database.

A mapping and/or control sequence (corresponding to a quantum circuit) may be provided as an output by the first computing device. The output may be used to control a quantum device. One embodiment of the invention may be considered as a compiler for providing quantum circuits.

The invention may be usable with at least one quantum device comprising at least one quantum processor. The quantum processor may comprise a plurality of qubits or other quantum elements arranged in a square lattice layout. Each quantum element may be connectable/couplable with at most four neighboring other quantum elements on the square lattice. The quantum processor may also comprise a plurality of qubits that are arranged in a plurality of square lattice qubit layouts.

In one embodiment, the invention may involve a method for determining a fermion-to-qubit mapping to be used for simulating a fermionic Hamiltonian on a quantum device. The method may additionally comprise determining a control sequence for performing a series of qubit interactions on a plurality of qubits on a quantum device based on the mapping, wherein the plurality of qubits on the quantum device is arranged into a two-dimensional square lattice qubit layout having a horizontal and a vertical dimension, where each qubit is arranged to interact with up to four neighboring qubits.

The method may involve receiving or obtaining parameters of a fermionic Hamiltonian to be considered. The obtained parameters may comprise at least a number of fermionic lattice sites L, a number of fermionic modes M in the fermionic lattice, and fermionic operators corresponding to interactions between the fermionic modes, i.e. a connectivity of the Hamiltonian to be considered, comprising information on which interaction terms (e.g. only NN or nonlocal interactions) are to be considered.

Parameters of the fermionic Hamiltonian may be obtained from a user, e.g. as a user input. Additionally or alternatively, at least some parameters of a fermionic Hamiltonian may be received e.g. via a database.

The method may then comprise projecting the fermionic lattice onto the qubit layout of the quantum device, such that every fermionic mode is assigned to a separate qubit of the quantum device. A qubit that is associated with a fermionic mode may be referred to as a physical qubit P and the mapping between the fermionic modes and the physical qubits is one to one. In the method, not all of the qubits of the quantum device involved in the projection are physical qubits P that are associated with fermionic modes. A plurality of further qubits involved in the projection are referred to as ancilla qubits A that are not assigned with any fermionic mode.

It may be noted that “physical” and “ancilla” qubits may physically be equivalent. The same hardware qubits that are used as physical qubits P may also be used as ancilla qubits A.

The physical qubits P and ancilla qubits A may be arranged in the horizontal dimension of the two-dimensional square lattice qubit layout into rows, each row comprising one or more strings P′ and one or more ancilla qubits A. The strings P′ and ancilla qubits A may be arranged within each row such that there are any number of, yet advantageously at most two, consecutive strings P′ and at most two consecutive ancilla qubits. Each string of physical qubits P′ may comprise at least one or more physical qubits P.

The strings P′ and ancilla qubits A may be arranged to follow one or more selected patterns. A pattern may refer to a selected number of consecutive strings P′ and ancilla qubits A. A pattern may comprise any number of strings P′ and any number of ancilla qubits A. In advantageous embodiments, a pattern may comprise one or two strings P′ and one or two ancilla qubits A. At most two consecutive ancilla qubits A in a row may yield optimal results. In some embodiments, more than two consecutive strings P′ in a row may be utilized. Some use cases for this may be with particular fermionic models with rare vertical edge operators and/or to reduce a qubit-to-mode ratio arbitrarily.

A resulting row of qubits in the horizontal dimension, which is obtained by a selected arrangement of physical qubits P and ancilla qubits A, is repeated along the vertical dimension to obtain a two-dimensional lattice of physical and ancilla qubits that are to be utilized in the mapping. Thus, the arrangement of physical qubits and ancilla qubits in each row of the qubit layout is the same, and each column of the qubit layout to be used in the mapping comprises either only physical qubits P or ancilla qubits A. This can be particularly useful, as a column of ancilla qubits may be utilized to perform qubit interactions more efficiently than with some other mappings, as qubit operations may involve less physical qubits P.

After determining an arrangement of physical qubits P and ancilla qubits A, wherein the rows are identical, each physical qubit is associated with at least one edge operator E and one vertex operator V. The edge and vertex operators are then utilized to map each interaction between fermionic modes to a qubit operator, after which a control sequence of qubit interactions may be determined, where the control sequence comprises at least the qubit operators determined by the mapping.

Patterns may be arranged consecutively in a row of qubits to provide sets of consecutive qubits and patterns may be repeated in a row of qubits. E.g. a row of qubits can comprise one selected pattern that is repeated, such as P′A, which will be depicted in the example further below. A row of qubits may also comprise sets of qubits with a plurality of different patterns, e.g. a row of qubits may comprise a first set with a first pattern, such as P′A, a second set with a second pattern, such as P′P′A, a third set with a third pattern. Any combination of different types of patterns for the consecutive sets may be considered.

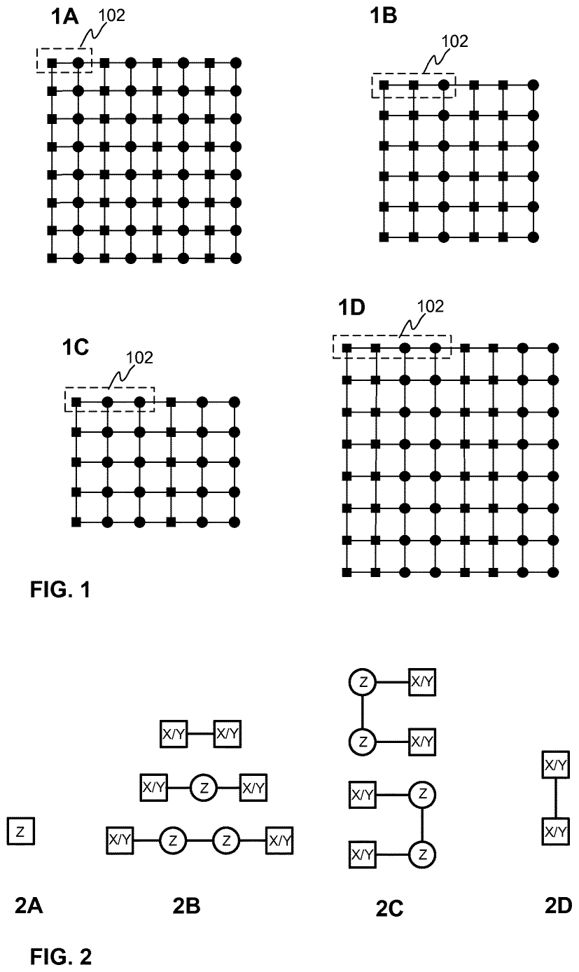

FIG. 1 shows examples of arrangements of strings P′ and ancilla qubits A into rows of qubits or horizontal single lines of qubits that are repeated to obtain a square lattice qubit layout. The total numbers of qubits depicted, number of patterns, number of times a pattern is repeated in a horizontal row, and number of rows in the vertical dimension are merely exemplary. A quantum device that is used may also comprise more qubits than those that are utilized in a projection or mapping.

In one exemplary embodiment, a pattern may be selected from the group of P′A, P′P′A, P′AA, and P′P′AA. FIG. 1 shows at 1A an arrangement of physical and ancilla qubits in a pattern 102 comprising arrangement of sets P′ and ancilla qubits A as P′A. FIG. 1B comprises an arrangement where the pattern 102 is P′P′A, while FIGS. 1C and 1D show arrangements with patterns P′AA and P′P′AA, respectively. Sets P′ are depicted as squares and ancilla qubits are depicted as circles. Qubit-to-mode ratios of the patterns considered are P′A 2.0, P′P′A 1.5, P′AA 3.0, and P′P′AA 2.0, when considering only mode per fermionic site, i.e. P′=P.

A row of qubits may be obtained by selecting a pattern and repeating the pattern in the horizontal dimension to obtain a desired/determined total number of strings P′ and ancilla qubits A in the row. A pattern may be repeated a selected number of times and a pattern may also be repeated such that at a beginning and/or end of a row or horizontal single line of qubits, a pattern is only partially provided. For example, a row of qubits with a pattern P′P′A may comprise strings P′ and ancilla qubits A arranged as: P′AP′P′AP′P′AP′, i.e. with the pattern being repeated in full two times and the sequence being “cut” as P′A in the beginning of the row and as P′ at the end of the row.

A number of consecutive physical qubits P that the string P′ corresponds to or comprises may be obtained based on the fermionic system and/or Hamiltonian that is considered. For instance, if a fermionic system comprises two fermionic modes per fermionic lattice site, a pattern of P′AA will correspond to PPAA when implemented in the row of qubits in the qubit layout.

A row of qubits in the horizontal direction may correspond to a sequence of qubits that may be obtained through further considerations regarding a fermionic system. Obtained or known information may indicate a number of fermionic lattice sites in two or three dimensions, comprising a number of fermionic lattice sites in a first dimension L₁, a number of fermionic lattice sites in a second dimension L₂, and optionally a number of fermionic lattice sites in a third dimension L₃, where a total number of fermionic lattice sites is L=L₁L₂ if two dimensions are considered or L=L₁L₂L₃ if three dimensions are considered.

In one embodiment, each fermionic mode of the fermionic Hamiltonian can be identified by indices i, j, k, indicating fermionic lattice site position along the respective dimensions, where i=[1, L₁], j=[1, L₂], k=[1, L₃], and the number of fermionic modes in each of the fermionic lattice sites identified by indices i, j, k can be labelled as Mᵢⱼₖ such that the total number of fermionic modes in the fermionic lattice is

$$M = {\sum }_{i = 1}^{{L}_{1}} {\sum }_{j = 1}^{{L}_{2}} {\sum }_{k = 1}^{{L}_{3}} {M}_{ijk} .$$

Here, each fermionic mode of the fermionic Hamiltonian can be identified by four indices i, j, k, l, where l=[1, Mᵢⱼₖ]. Projecting the fermionic lattice onto the square lattice qubit layout of the quantum device may comprise assigning each fermionic mode, identified by the four indices i, j, k, l, of the fermionic lattice to a physical qubit Pᵢⱼₖₗ of the quantum device, where the indices of each physical qubit identify the fermionic mode with which the physical qubit is assigned.

The physical qubits Pᵢⱼₖₗ, each assigned with a fermionic mode identified by the indices i, j, k, l, may be arranged within the qubit layout such that:
each row of the qubit layout comprises L₁ strings P′, each string denoted as P′ᵢⱼ to indicate that the string comprises a number of physical qubits Pᵢⱼₖₗ assigned with fermionic modes associated with fermionic lattice sites with position indices i and j, where the number of physical qubits within a string P′ᵢⱼ is equal to

$${\sum }_{k = 1}^{{L}_{3}} {M}_{ijk} ,$$

each physical qubit with a lower index i is arranged, in the horizontal dimension, before any physical qubit with a higher index i,
the number of rows in the qubit layout that is participating in the projecting is equivalent to L₂, and each physical qubit with a lower index j is arranged, in the vertical dimension, before any physical qubit with a higher index j, and
   associating physical qubits within each string P′ with varying indices k and/and arranging their respective order depending on the fermionic interactions.

Associating each physical qubit P with at least one edge operator E and one vertex operator V may comprise:
associating each physical qubit with a vertex operator Vₚ, wherein Vₚ is a Pauli operator of first type, selected from Pauli operator types X, Y and Z, acting on physical qubit p,
for any pair of physical qubits p and q, which in the horizontal dimension are either direct neighbors without any physical or ancilla qubits between them, or are separated by one or two ancilla qubits, define a horizontal edge operator

$${E}_{pq}^{H} ,$$

associated with said qubits, wherein

$${E}_{pq}^{H}$$

is a tensor product of a number of Pauli operators comprising:
   at least two Pauli operators, each of second or third type, selected from Pauli operator types X, Y, and Z, and acting on qubits p and q respectively, and
   if any ancilla qubits are present between the physical qubits p and q along the horizontal dimension, additional Pauli operators, each of first type, acting on each of said, if any present, ancilla qubits,
      wherein when two horizontal edge operators act on the same qubit q, if the first of the two horizontal edge operators

$${E}_{pq}^{H 1}$$

acts on the qubit q with a Pauli operator of second type, then the second of the two horizontal edge operators

$${E}_{pq}^{H 2}$$

acts on the qubit q with a Pauli operator of third type and vice versa.

The associating may further comprise:
for any pair of physical qubits p and q, which in the vertical dimension are direct neighbors without any physical or ancilla qubits between them, and where said pair of qubits is adjacent to a pair of ancilla qubits a and b, where said ancilla qubits a and b are direct neighbors in the vertical dimension, arranged adjacent to the qubits p and q respectively, define a vertical edge operator

$${E}_{pq}^{V} ,$$

associated with said qubits p, q, a, b, wherein

$${E}_{pq}^{V}$$

is a product of four Pauli operators, each of second or third type and each acting on one of the qubits p, q, a, b such that each of the four Pauli operators acts on a different qubit, wherein
   the Pauli operators acting on the ancilla qubits a and b are of different type,
   the Pauli operator acting on the physical qubit p is of the same type as the Pauli operator acting on the physical qubit q and forming a part of the horizontal edge operator acting on at least the physical qubit p and the ancilla qubit a, and similarly the Pauli operator acting on the physical qubit q is of the same type as the Pauli operator acting on the physical qubit p and forming a part of the horizontal edge operator acting at least on the physical qubit q and the ancilla qubit b,
   a vertical edge operator is referred to as a first vertical edge operator

$${E}_{pq}^{V 1}$$

when the ancilla qubits a and b are arranged on a first side, e.g. right-hand side, of the physical qubits p and q respectively along the horizontal dimension, or as a second vertical edge operator

$${E}_{pq}^{V 2}$$

when the ancilla qubits a and b are arranged on a second side, e.g. left-hand side, of the physical qubits p and q along the horizontal dimension.

Further, when two vertical edge operators act on the same ancilla qubit, if one of the two vertical edge operators acts on said ancilla qubit with a Pauli operator of second type, then the other of the two vertical edge operators may act on said ancilla qubit with a Pauli operator of third type and vice versa. In most use cases, for any first and any second vertical edge operators acting on ancilla qubits a1, b1 and a2, b2 respectively, the Pauli operator of a first vertical edge operator acting on an ancilla qubit a1 is of different type than the Pauli operator of a second vertical edge operator acting on an ancilla qubit a2, if the ancilla qubits a1 and a2 are arranged on a side in the same direction along the vertical dimension of ancilla qubits b1 and b2 respectively. A first qubit that is arranged on a first side of a second qubit may refer to a qubit that is adjacent to the second qubit in a row or horizontal line of qubits, where a third qubit that is on a second side of the second qubit is arranged adjacent to the second qubit in the row of qubits, but on a side that is opposite to the side at which the first qubit is located.

A selection of Pauli operator types that shall be used (i.e. which Pauli operator is selected as the first type, second type, and third type) may depend on the quantum device that is considered by the mapping. Which type of gates are native to the quantum device may be taken into account and the types of Pauli operators assigned to the vertex and edge operators may be adapted to tailor the mapping according to the native gates of the qubit hardware to be utilized.

Pauli operator types that shall be used may in one embodiment be selected also separately regarding each physical qubit P. For instance, for a first physical qubit the Pauli operator of first type may be oz, while for a second physical qubit the Pauli operator of the first type may be oy. In such cases, e.g. vertex operators may be different for different physical qubits P.

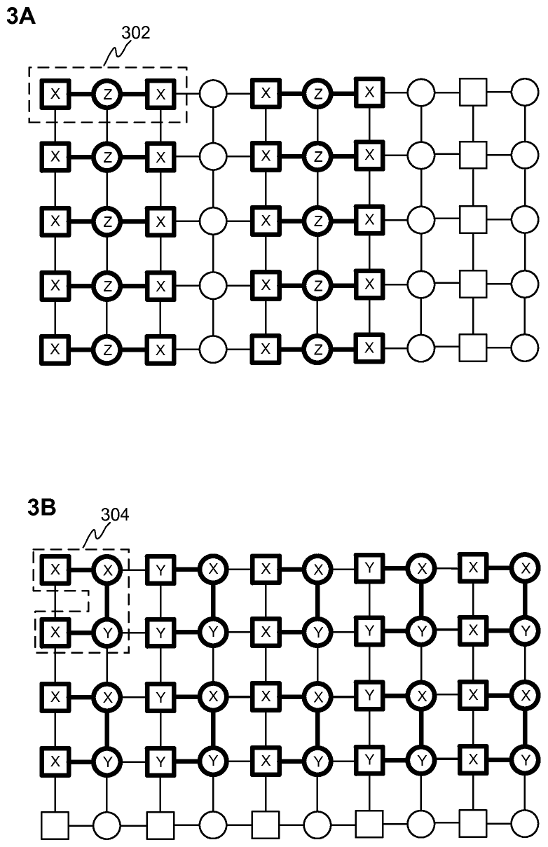

In connection with some advantageous mappings, however, vertex operators may be equivalent for all physical qubits P. One example of selection of Pauli operator types for vertex operators is Vₚ=Zₚ, where Zₚ is a Pauli operator oz acting on qubit p. Vertex and edge operators corresponding to this selection are depicted in FIG. 2. FIG. 2A depicts the vertex operator, while FIG. 2B depicts the possibilities for horizontal edge operators and FIG. 2C shows possible vertical edge operators which may be used in connection with most qubits and qubit layouts. FIG. 2D shows a vertical edge operator that may be used in rare cases when the two associated physical qubits P may be connected without ancilla qubits A. This situation may arise at the borders of a finite system, e.g. in connection with a honeycomb type lattice geometry, where it is possible that no ancilla qubits are required to be used between at least some of the possible pairs of physical qubits at the edges of the qubit lattice.

The different possibilities for edge operators depend on the placement of ancilla qubits in the vicinity of the considered physical qubits. In FIG. 2, physical qubits (or physical qubit strings P′) are depicted as squares and ancilla qubits as circles, while the notations X/Y and X/Y in connection with physical qubits in the same operators indicate that both qubits are acted on by operators that correspond to either σ_{X} operators or σ_{Y} operators (in figures that follow, the notation X/Y and Y/X in connection with the physical qubits in the same operator indicate that one qubit is acted on by an operator corresponding to either σ_{X} or σ_{Y}, while the other qubit is acted on by an operator σ_{X} or σ_{Y} which is different from the operator acting on the one qubit). These operator selections are advantageous for quantum devices where native gates correspond to e^{iαZ}^{ₚ}^{Z}^{_{q}} and e^{iα(X}^{ₚ}^{X}^{_{q}}^{+Y}^{ₚ}^{Y}^{ₐ}⁾. Such operator selections are also advantageous for quantum devices where native gates correspond to fSIM gates (covering both of the previous and also further gates), where

$${fSIM}_{ij} ( θ , ϕ ) = {e}^{i \frac{θ}{2} ( {X}_{i} {X}_{j} + {Y}_{i} {Y}_{j} ) + i \frac{ϕ}{4} ( {Z}_{i} + {Z}_{j} - {Z}_{i} {Z}_{j} )} .$$

FIG. 2B shows that Pauli strings corresponding to horizontal edge operators may be formed by either σ_{X} or σ_{Y} operators on two qubits at the ends combined with up to two intermediate ancilla qubits being acted on by σ_{z} operators. The σ_{X} and σ_{Y} may be altered between neighboring horizontal edges, which ensures that they mutually anti-commute. One thus has the choice between horizontal edges of Pauli weight between two and four, depending on the selection of the pattern to be used.

As seen from FIG. 2C, all vertical edge operators as depicted in connection with a qubit layout usually have a square-like shape comprising two physical qubits P and two ancilla qubits A. The physical qubits P may reside either to the left or to the right of the ancilla qubits A and similarly to the horizontal edge operators acting on ancilla qubits A as well as physical qubits P, both Pauli operators acting on physical qubits P in vertical edge operators should carry either a σ_{X} or σ_{Y}, the choice of which should be the same as horizontal edge operators to be utilized in the same mapping, which horizontal edge operators they shall anti-commute with.

In the present invention, an arrangement of ancilla qubits A and physical qubits P in a row of qubits or pattern may be selected first and thereafter the edge and/or vertex operators may be selected based on the arrangement of qubit or pattern. Alternatively, edge and/or vertex operators may be determined for a plurality of different arrangement or patterns, and an arrangement of physical qubits P and ancilla qubits A may be selected thereafter, optionally based on criteria that may at least partially depend on characteristics of the operators.

In one embodiment, the physical qubits P in a row of qubits in the horizontal dimension may be grouped into pairs of physical qubits alternatingly labelled as even or odd, wherein ancilla qubits A are not considered, and neighboring pairs of such even or odd labelled qubit pairs share a physical qubit P, wherein the associating each physical qubit P with at least one edge operator may comprise:
for each even pair of physical qubits p and q and the one or more ancilla qubits between them if present, define an even horizontal edge operator

$${E}_{pq}^{H 1}$$

associated with said qubits, wherein
   if p and q are direct neighbors not separated by an ancilla qubit a,

$${E}_{pq}^{H 1}$$

is a product of two Pauli operators of second type acting on physical qubits p and q, respectively, optionally wherein

$${E}_{pq}^{H 1} = {X}_{p} {X}_{q}$$

wherein X is a Pauli operator σ_{X} acting on physical qubit p or q,
if p and q are separated by one ancilla qubit a,

$${E}_{pq}^{H 1}$$

is a product of a Pauli operator of second type acting on physical qubit p, a Pauli operator of first type acting on ancilla qubit a, and a Pauli operator of second type acting on physical qubit p, optionally wherein

$${E}_{pq}^{H 1} = {X}_{p} {Z}_{a} {X}_{q} ,$$

wherein X is a Pauli operator σ_{X} acting on physical qubit p or q and Z is a Pauli operator σ_{Z} acting on ancilla qubit a,
if p and q are separated by two ancilla qubits a and b,

$${E}_{pq}^{H 1}$$

is a product of a Pauli operator of second type acting on physical qubit p, a Pauli operator of first type acting on ancilla qubit a, a Pauli operator of first type acting on ancilla qubit b, and a Pauli operator of second type acting on physical qubit p, optionally wherein

$${E}_{pq}^{H 1} = {X}_{p} {Z}_{a} {Z}_{b} {X}_{q} ,$$

for each odd pair of physical qubits p and q and the one or more ancilla qubits between them if present, define an odd horizontal edge operator

$${E}_{pq}^{H 2}$$

associated with said qubits, wherein
   if p and q are direct neighbors not separated by an ancilla qubit,

$${E}_{p q}^{H 2}$$

is a product of two Pauli operators of third type acting on physical qubits p and q, respectively, optionally wherein

$${E}_{p q}^{H 2} = {Y}_{p} {Y}_{q}$$

wherein T is a Pauli operator σ_{Y} acting on physical qubit p or q,
if p and q are separated by one ancilla qubit a,

$${E}_{p q}^{H 2}$$

is a product of a Pauli operator of third type acting on physical qubit p, a Pauli operator of first type acting on ancilla qubit a, and a Pauli operator of third type acting on physical qubit p, optionally wherein

$${E}_{p q}^{H 2} = {Y}_{p} {Z}_{a} {Y}_{q} ,$$

if p and q are separated by two ancilla qubits a and b,

$${E}_{p q}^{H 2}$$

of a Pauli operator of third type acting on physical qubit p, a Pauli operator of first type acting on ancilla qubit a, a Pauli operator of first type acting on ancilla qubit b, and a Pauli operator of third type acting on physical qubit p, optionally wherein

$${E}_{p q}^{H 2} = {Y}_{ρ} {Z}_{a} {Z}_{b} {Y}_{q} ,$$

for each pair of physical qubits p and q, which in the vertical dimension are direct neighbors without any physical or ancilla qubits between them, define a vertical edge operator

$${E}_{p q}^{V}$$

associated with said qubits, wherein
   if ancilla qubits a and b are direct neighbors of p and q in the horizontal dimension in a first direction, with p and q having no other ancilla qubits as direct horizontal neighbors, and wherein a and b are associated with even horizontal edge operators,

$${E}_{p q}^{V}$$

is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein

$${E}_{p q}^{V} = {X}_{p} {X}_{a} {Y}_{b} {X}_{q} ,$$

if ancilla qubits a and b are direct neighbors of p and q in the horizontal dimension in the first direction, with p and q having no other ancilla qubits as direct horizontal neighbors, and wherein a and b are associated with odd horizontal edge operators,

$${E}_{p q}^{V}$$

is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein

$${E}_{p q}^{V} = {Y}_{p} {X}_{a} {Y}_{b} {Y}_{q} ,$$

if ancilla qubits a and b are direct neighbors of p and q in the horizontal dimension in a second direction, with p and q having no other ancilla qubits as direct horizontal neighbors, and wherein a and b are associated with even horizontal edge operators,

$${E}_{p q}^{V}$$

is a product of a Pauli operator of the second type acting on physical qubit p, a Pauli operator of the third type acting on ancilla qubit a, a Pauli operator of the second type acting on ancilla qubit b, and a Pauli operator of the second type acting on physical qubit q, optionally wherein

$${E}_{p q}^{V} = {X}_{p} {Y}_{a} {X}_{b} {X}_{q} ,$$

if ancilla qubits a and b are direct neighbors of p and q in the horizontal dimension in the second direction, with p and q having no other direct ancilla qubits as horizontal neighbors, and wherein a and b are associated with odd horizontal edge operators,

$${E}_{p q}^{V}$$

is a product of a Pauli operator of the third type acting on physical qubit p, a Pauli operator of the third type acting on ancilla qubit a, a Pauli operator of the second type acting on ancilla qubit b, and a Pauli operator of the third type acting on physical qubit q, optionally wherein

$${E}_{p q}^{V} = {Y}_{p} {Y}_{a} {X}_{b} {Y}_{q} ,$$

if p and q are direct neighbors of ancilla qubits a and b in the horizontal dimension in the first direction, with ancilla qubits c and d as direct neighbors in the second direction,
   for the first direction:

$${E}_{pq}^{V}$$

is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein

$${E}_{pq}^{V} = {X}_{p} {X}_{a} {Y}_{b} {X}_{q} , or {E}_{pq}^{V}$$

is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein

$${E}_{pq}^{V} = {Y}_{p} {X}_{a} {Y}_{b} {Y}_{q} ,$$

for the second direction:

$${E}_{pq}^{V}$$

is a product of a Pauli operator of the second type acting on physical qubit p, a Pauli operator of the third type acting on ancilla qubit c, a Pauli operator of the second type acting on ancilla qubit d, and a Pauli operator of the second type acting on physical qubit q, optionally wherein

$${E}_{pq}^{V} = {X}_{p} {Y}_{c} {X}_{d} {X}_{q} , or {E}_{pq}^{V}$$

is a product of a Pauli operator of the third type acting on physical qubit p, a Pauli operator of the third type acting on ancilla qubit c, a Pauli operator of the second type acting on ancilla qubit d, and a Pauli operator of the third type acting on physical qubit q, optionally wherein

$${E}_{pq}^{V} = {Y}_{p} {Y}_{c} {X}_{d} {Y}_{q} .$$

For the embodiment stated above, preferably, X corresponds to a Pauli operator of the second type acting either on physical qubits or on ancillas, for example noted as Xₚ when acting on physical qubit p and noted X_{c} when acting on ancilla qubit c. Preferably, Y corresponds to a Pauli operator of the third type acting either on physical qubits or ancilla, for example noted Y_{c} when acting on ancilla qubit c and noted Yₚ when acting on physical qubit p. Preferably, Z corresponds to a Pauli operator of the first type acting either on physical qubits or ancilla, for example noted Z_{c} when acting on ancilla qubit c and noted Zₚ when acting on physical qubit p.

A pattern may be selected based on determining maximum Pauli weights of edge operators associated with at least two patterns, and selecting a pattern that is associated with a lowest or selected maximum Pauli weight.

A pattern may be selected based on determining a circuit depth of a control sequence separately associated with at least two patterns, and selecting a pattern that is associated with a lowest or selected circuit depth.

A pattern may be selected by determining a number and/or type of gates comprised in a control sequence separately associated with at least two patterns, and selecting a pattern that is associated with a lowest or selected number of gates and/or a pattern that is associated with selected types of gates, such as one comprising at least a selected amount of native gates. A qubit-to-mode ratio may also be considered when selecting a pattern.

Operators according to FIGS. 2A, 2B, 2C, and 2D may determine a pool of operators based on which selected operators can be used to determine a mapping and select a pattern.

When selecting a pattern or row of qubits based on operators from a pool of operators and considering different criteria for the selection, when choosing between weight-two and weight-three horizontal edges in contrast to weight-four horizontal edges, a trade-off between lowering a qubit-to-mode ratio (weight-two and weight-three edges) and a higher degree of parallelism in implementing corresponding vertical edge operators (weight-four horizontal edges) may be required.

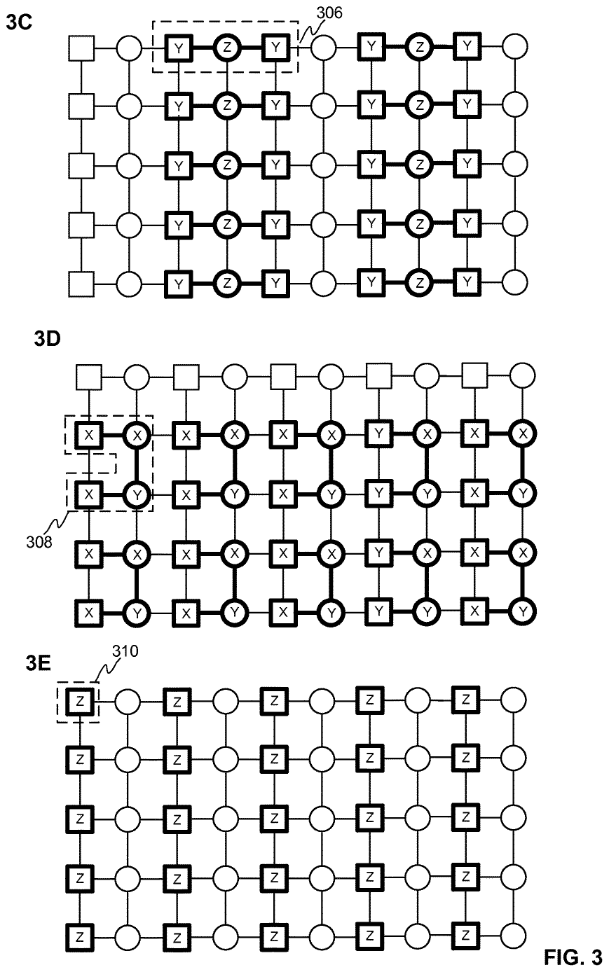

FIGS. 3A-3E show examples of vertex and edge operators for a qubit layout corresponding to a selection of a P′A pattern that is repeated in the horizontal dimension to obtain the row of qubits. This example may, regarding the qubit layout in terms of pattern selection and/or regarding the selection of edge and vertex operators, may be particularly well-suited for simulations involving the spinless Fermi-Hubbard model. In this example, one fermionic lattice site contains only one mode. In this example, a fermionic lattice comprises 5 lattice sites in the first dimension and 5 lattice sites in the second dimension (L₁=5, L₂=5, L₃=1). The pattern, selected operators, and characteristics of the fermionic system are merely exemplary.

In the example of FIG. 3, the fermionic Hamiltonian may be mapped to a qubit lattice comprising at least 10 qubits in the horizontal dimension and at least 5 qubits in the vertical dimension. In FIG. 3, squares represent physical qubits P and circles represent ancilla qubits A. FIGS. 3A and 3C show horizontal edge operators, FIGS. 3B and 3D show vertical edge operators, and FIG. 3E shows vertex operators. Each figure represents a group of operators which may be implemented in parallel, as they are acting on different/independent qubits. The operators are depicted through marking associated qubits with letters corresponding to the associated Pauli operator types and showing associated qubits and connections with bold lines. The selected areas 302, 304, 306, 308, and 310 may aid in visualizing one of the operators that is depicted, with 302 and 306 pointing out horizontal edge operators, 304 and 308 pointing out vertical edge operators, and 310 pointing out a vertex operator.

Relating to the fermionic Hamiltonians that are to be considered, it may be shown that (quadratic) fermionic hopping operators are of the same Pauli weight as the edge operators connecting the physical qubits related to the modes on which they are defined (this means Pauli weights of two, three or four). For (quartic) interaction operators acting on only two modes, as found in Fermi-Hubbard models, the Pauli weight is double that of a single vertex operator, meaning Pauli weight two.

If there is more than one fermionic mode per fermionic lattice site, physical qubits corresponding to these modes may be placed next to each other in a horizontal row of qubits. Thus, a string P′ may comprise at least a number of physical qubits P that corresponds to a number of modes comprised in an associated fermionic lattice site. A string P′ may be associated with only one fermionic lattice site in the first dimension of the fermionic lattice. The physical qubits P associated with the same fermionic lattice site may be connected by horizontal weight-two edges. This may be allowed, as only two vertical edge operators per fermionic lattice site may be required. For different modes of the same fermionic lattice site, an fSWAP network may be utilized to bring the modes together, and thus further vertical connectivity via edge operators may not be needed.

Different modes of a fermionic lattice site may refer to different modes relating to different orbitals or to different spin types considered in connection with one orbital. A fermionic system may comprise any number of orbitals, and each orbital may comprise any number of spin types.

When an orbital associated with a fermionic lattice site comprises a plurality of different spin types, the modes corresponding to these may advantageously be assigned to different physical qubits P such that they are separated by one physical qubit P. This may ensure that these modes will never be further away from each other than one physical qubit P when using an fSWPAP network.

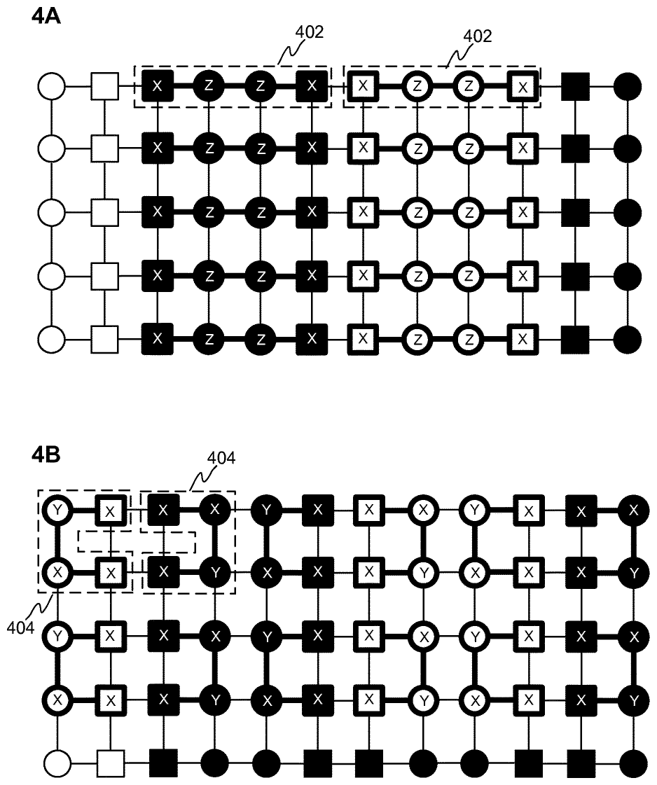

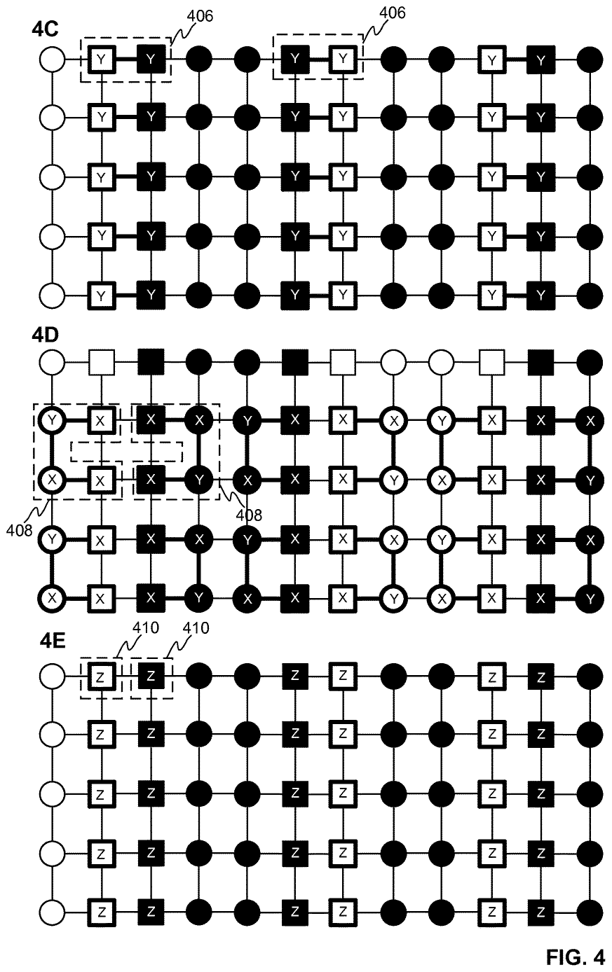

FIG. 4 depicts an example of edge and vertex operators that may be utilized when a pattern P′AA is chosen, and where the pattern being repeated is truncated, such that each row actually begins and ends with one ancilla, and a fermionic system comprises two modes per lattice site. Thus in this case, the string P′ corresponds to two physical qubits, i.e. PP. Squares represent physical qubits P and circles represent ancilla qubits A. In this example, it is considered that each lattice site comprises one orbital, each with two spin types, here “up” and “down”. Squares that are filled (black) correspond to one spin type mode, e.g. up, while squares that are empty (no fill) correspond to the other spin type mode, e.g. down.

FIGS. 4A and 4C show horizontal edge operators, FIGS. 4B and 4D show vertical edge operators, and FIG. 4E shows vertex operators. The group of operators in each separate figure may be implemented in parallel, as they are acting on different qubits. The operators are depicted through marking associated qubits with letters corresponding to the associated Pauli operator types and showing associated qubits and connections with bold lines. The selected areas 402 and 406 point out horizontal edge operators, 404 and 408 point out vertical edge operators, and 410 points out vertex operators, each shown for both spin up and spin down modes. Each edge operator thus acts on or involves physical qubits that are assigned with fermionic modes that correspond to each other on different fermionic lattice sites.

It should be noted that FIGS. 3 and 4 depict examples of edge and vertex operators that may be selected in connection with the selected pattern or row of qubits. Also other types of edge and vertex operators are possible. The exemplary operators may yield optimal results taking into account some considerations or criteria e.g. regarding a resulting quantum circuit, but also other selections of edge and vertex operators may give lower Pauli weights for operators than prior art mappings, for instance.

It may also be noted that if the fermionic lattice is three-dimensional, then each lattice site in the third dimension (L₃) may be treated, in the projecting, in the same way as further modes or orbitals of the fermionic lattice sites in the first dimension. Thus, a string P′ may comprise a number of physical qubits P that corresponds to a number of modes comprised in an associated lattice site in the first dimension plus a number of physical qubits that corresponds to a number of modes comprised in each fermionic lattice site in the third dimension. However, it may be noted that in this case the obtained circuit depth may no longer be constant depth or scale linearly with the size of the fermionic system, but the circuit depth will scale linearly with the third dimension and the number of fermionic modes per lattice site.

In cases where more than one fermionic mode per fermionic lattice site is considered, the different modes may relate to different orbitals and/or different spin types of the same orbital. In these cases however, the string P′ may then comprise a plurality of consecutive physical qubits P that form a chain of modes. The modes associated with physical qubit at the ends of one chain or string P′ may be readily involved in interactions with one or more modes of further fermionic lattice sites that are associated with physical qubits of a further string P′, where such interactions are made possible through edge and vertex operators that may connect the qubits associated with the modes.

In some cases, there may thus be a chain of fermionic modes associated with the qubits within in a row, where one or more modes are initially internal modes that are positioned at middle sites in the string and are associated with internal physical qubits of the string P′. Such internal modes are advantageously repositioned such that they may be located at an end position of the chain of fermionic modes in order to be involved in one or more interactions.

Repositioning of fermionic modes may be carried out by utilizing fSWAP operators, so that one or more internal modes are shifted to the first direction or second direction (left or right) along the row of qubits. A network of fSWAP operators comprising M/L−2 parallel fSWAP layers may swap fermionic modes within a string P′ of M/L modes by alternating two layers of fSWAPs between all neighboring qubit pairs, which may be alternatingly labelled as either even (for instance physical qubits numbered as 2n, 2n+1) or odd (e.g. physical qubits numbered as 2n+1, 2n+2).

The assigning of modes to an arrangement of a row of qubits may comprise ordering of the modes so that an fSWAP network may be efficiently used to bring the relevant modes next to each other on the connectivity graph corresponding to the qubit layout projection. The assigning of modes as disclosed herein may lead to efficient simulation of fermionic Hamiltonians, as a plurality of operations may be performed in parallel. Advantageously, there may be no physical qubits assigned with fermionic modes that do not participate in qubit interactions during a layer of a control sequence or quantum circuit where qubit interactions corresponding to fermionic interactions are applied.

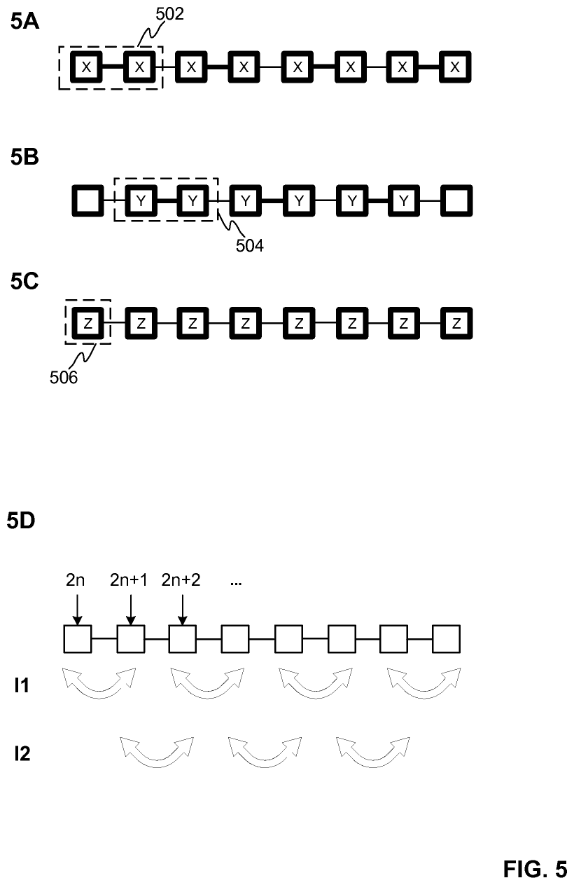

FIG. 5 depicts one example of modes associated with one fermionic lattice site and how an fSWAP network may be selected to provide an optimal fSWAP network for this particular example. An fSWAP network may comprise a plurality of fSWAP operators, wherein the network comprises a plurality of layers, each layer comprising one or more fSWAP operators, where the operators in one layer operate on separate/different qubits.

FIGS. 5A-5C depict physical qubits P that are each assigned with a mode of a fermionic lattice site. The physical qubits of FIG. 5 may for instance show a portion of a qubit layout or row of qubits, and could be involved in a larger qubit layout, constituting a string P′ of a qubit layout. In the example of FIG. 5, the considered fermionic lattice site comprises 8 modes.

FIGS. 5A and 5B show (weight two) horizontal edge operators with one operator being highlighted with the selections 502 and 504, while FIG. 5C shows vertex operators, with 506 highlighting one of the vertex operators.

FIG. 5D illustrates an optimal fSWAP network that may be used in connection with the modes illustrated in FIGS. 5A-5C. The network of FIG. 5D may ensure that during one full control sequence comprising at least the fSWAP network and qubit operators corresponding to a desired Hamiltonian and fermionic system considered, each mode of the fermionic lattice site is associated, at some point, at both ends of the chain or string depicted and all mode-pairs may be brought together, meaning that they will at some point be associated with physical qubits that are direct neighbors. A first fSWAP layer 11 may exchange the fermionic modes assigned to physical qubits in each pair of physical qubits labelled with a first label (here “even”), while a second fSWAP layer 12 may exchange the fermionic modes assigned to physical qubits in each pair of physical qubits labelled with a second label (here “odd”).

With the mappings of the present invention, the number of necessary fSWAP operations may be independent of the dimensions of the considered fermionic lattice, considering at least two-dimensional fermionic lattices.

In cases where fermionic lattice sites of a fermionic system comprise different numbers of modes per fermionic lattice site, one or more “extra” physical qubits P may be utilized in at least one string P′ (corresponding to the string or strings that is/are associated with a fermionic lattice site with a smaller number of modes than another lattice site) as “dummy” modes in order to be able to efficiently utilize the fSWAP networks.

Composite edge operators may be defined that correspond to an interaction between any two physical qubits that have no direct edge operator defined between them, as long as two or more other edge operators have been defined that act on and correspond to interactions between physical qubits that ultimately define a chain of physical qubits, wherein the chain comprises physical qubits, the end points of which are the physical qubits acted on by the composite edge operator, such that neighboring physical qubits in the chain are acted on by a mutual edge operator.

The possibility of utilizing composite edge operators leads to the possibility of determining qubit interactions through which simulation of fermionic systems or Hamiltonians where higher than square connectivity (NN) is considered. For instance, a version of the Fermi-Hubbard model which includes next-nearest-neighbor (NNN) hopping terms is believed to represent the minimal description of high-temperature copper-oxide superconductors. The quartic interaction term (U) also renders it extremely hard to solve for classical methods, especially when U is large.

The Fermi-Hubbard model on a fermionic square lattice geometry is considered to be the canonical version of the model. However, the Fermi-Hubbard model has also been extensively studied on other lattice geometries, especially the triangular, honeycomb and Kagome lattices as for these, real material realizations exist. In prior art methods for fermion-to-qubit mappings, these other non-square lattice geometries have often not been considered. A few investigations of fermion-to-qubit mappings with e.g. honeycomb and

Kagome lattices have been carried out but in these, separate mappings for each fermionic lattice geometry are determined. Furthermore, these mappings have mostly not been designed to fit on square lattices of four-connected qubit layouts and have been optimized for low qubit-to-mode ratios instead of circuit depths.

Other models can be considered such as the Hubbard-Kanamori model, which includes a wider range of quartic terms than the Fermi-Hubbard model, namely the inter-band density between different spins (U₁), the inter-band density between same spin (U₂) and the pair-hopping and spin-exchange interactions (J).

With the present invention, it is possible to determine edge operators (either as direct edge operators that are straightforwardly determined in the connectivity graph or as composite edge operators that are determined combinations of the direct edge operators) that enable qubit interactions between all pairs of physical qubits P that correspond to all possible NN and NNN interactions between associated fermionic modes. Through this, also alternative fermionic lattice geometries may be projected to a square lattice qubit layout.

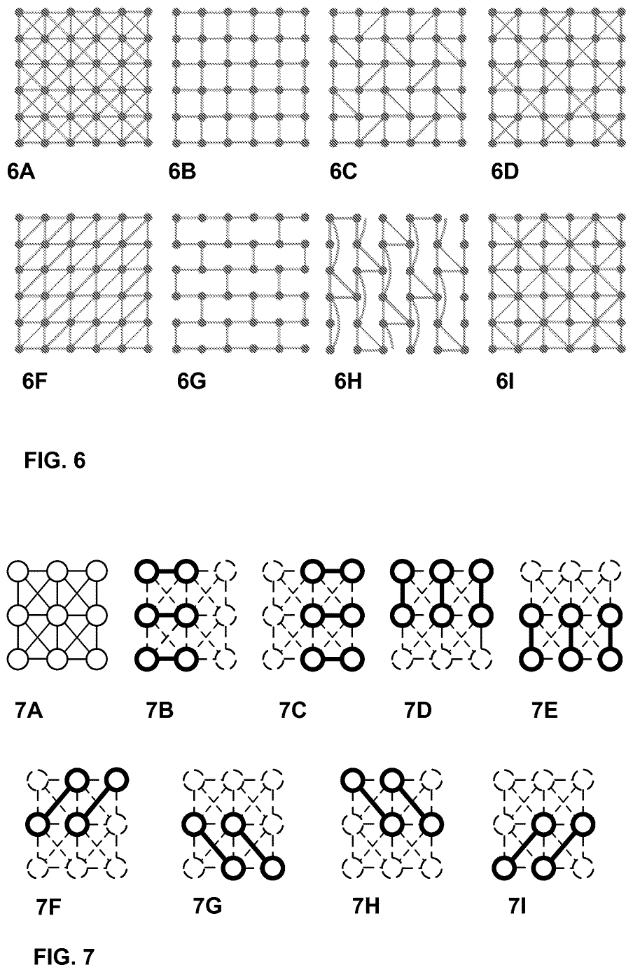

FIGS. 6A to 6I show alternative fermionic lattice geometries (in two dimensions) and associated connectivities between sites that may be efficiently embedded into a square lattice qubit layout with the projection, association of fermionic sites with physical qubits, and mapping of the present invention. FIG. 6A shows a square lattice with NNN connectivity, FIG. 6B shows a square lattice with NN connectivity, FIG. 6C shows a Shastry-Sutherland lattice, FIG. 6D shows a checkerboard lattice, FIG. 6F shows a triangular lattice, FIG. 6G shows a honeycomb lattice, FIG. 6H shows a Kagome lattice, and FIG. 6I shows a tetrakis lattice. The method of the present invention may maximally utilize the available qubits or available qubits to associate with fermionic lattice sites that are present in a square lattice qubit layout. Within at least a selected subset or selected square lattice portion of a square lattice layout of a quantum device, all (physical) qubits may be utilized in the projected lattice geometry.

Provided circuit depths associated with at least some of the lattice geometries of FIG. 6 may be optimal with the present invention. Provided circuit depths associated with the lattice geometries of FIG. 6 may not be optimal for all lattice geometries, yet the present invention may still provide benefits. This is because the circuit depth may still be at least near or comparable to circuit depths obtained with prior art solutions, while a high level of abstraction is provided, i.e. the mappings are suitable for use with many types of fermionic Hamiltonians, and additional labor for providing mappings associated with each lattice geometry individually may be avoided.

The present invention may enable determining edge operators that connect two physical qubits through a vertical stack of ancilla qubits. Here, multiple vertical edges may be composed to reach a further neighbor (which are not connected by a direct determined edge operator) and the cost may only grow by one ancilla qubit for each unit of distance on the fermionic graph.

With the present invention, any fermionic Hamiltonian where min (Dₓ, D_{y})=1 where D_{x,y}=max (d_{x,y}) and d_{x,y} are the horizontal/vertical components of the Manhattan distances between pairs of physical qubits which are acted on by composite edge operators which correspond to existing edge operators on the fermionic connectivity graph may be mapped. The Pauli weights of determined composite edge operators is equal to dₓ+d_{y}+d_{A}−1, where d_{A} is the number of vertical ancilla qubit layers between the physical qubits.

FIGS. 7-9 illustrate one example of applying the method of the present invention for simulation of the spinless Fermi-Hubbard model (one mode per fermionic lattice site) with NN and NNN hoppings/interactions. The considered example is for a 3×3 fermionic lattice (L₁=3, L₂=3, L₃=1) that is projected onto a qubit layout that has three horizontal rows, with one row having an arrangement of physical qubits and ancilla qubits of: PAPAPA (a pattern of PA then being used, with P′ being equal to P since only one mode per lattice site is considered).

FIG. 7 shows at 7A the fermionic lattice and the considered connectivity. FIGS. 7B-71 specify (highlight with bold lines) the different hopping terms on the fermionic lattice that are to be considered: first horizontal interactions at 7B, second horizontal interactions at 7C, first vertical interactions at 7D, second vertical interactions at 7E, first diagonal interactions at 7F, second diagonal interactions at 7G, third diagonal interactions at 7H, and fourth diagonal interactions at 7I. In FIG. 7, the circles represent different fermionic lattice sites. In the separate subfigures, operators which may be applied in parallel are depicted on the same lattice.

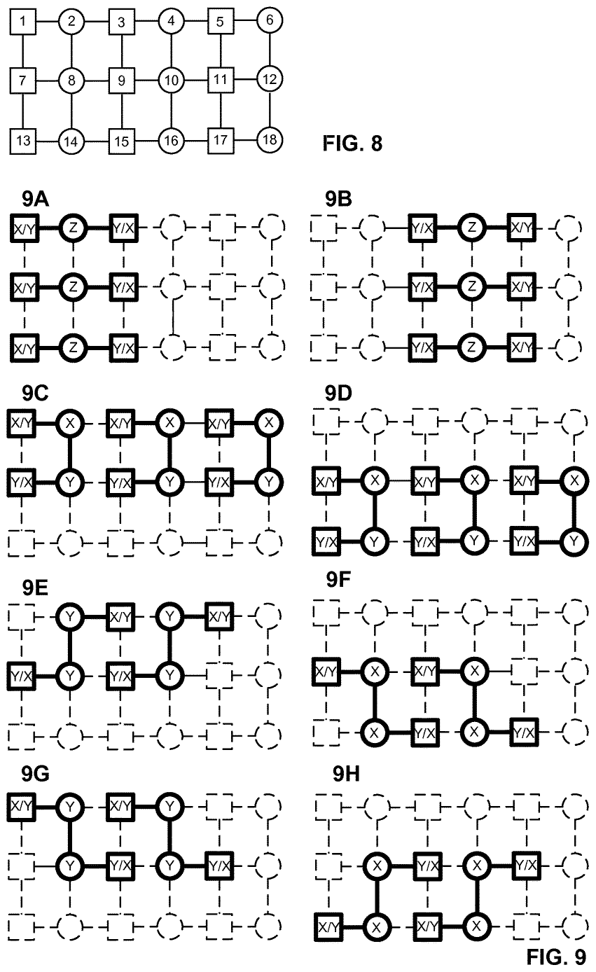

FIG. 8 illustrates a qubit layout that may be used to simulate a fermionic Hamiltonian that involves the 3×3 fermionic lattice and interactions shown in FIG. 7. In FIG. 8, squares represent physical qubits and circles represent ancilla qubits, with FIG. 8 showing also a numbering of qubits that may be employed.

FIGS. 9A to 9H depict hopping operators (i.e. operators comprising one edge operator multiplied by one vertex operator) that may be determined that can be utilized in a fermion-to-qubit mapping and associated determination of qubit operators involving a qubit layout of FIG. 8 and corresponding to the fermionic lattice and fermionic interactions of FIG. 7.

The hopping operator depicted by FIG. 9A corresponds to the first horizontal interactions of FIG. 7B, FIG. 9B corresponds to the second horizontal interactions of FIG. 7C, FIG. 9C corresponds to the first vertical interactions of FIG. 7D, FIG. 9D corresponds to the second vertical interactions of FIG. 7E, FIG. 9E corresponds to the first diagonal interactions of FIG. 7F, FIG. 9F corresponds to the second diagonal interactions of FIG. 7G, FIG. 9G corresponds to the third diagonal interactions of FIG. 7H, and FIG. 9H corresponds to the fourth diagonal interactions of FIG. 7I.

Horizontal or vertical hopping operators may correspond to VᵢEᵢⱼ, where Eᵢⱼ is the corresponding edge operator in the horizontal or vertical direction, whilst diagonal hopping operators may be obtained as composite operators and may correspond to VᵢEⱼₖEₖⱼ, where one of the edge operators is a corresponding horizontal edge operator and the other edge operator is a corresponding vertical edge operator.

Table 1 below shows Pauli weights for the different edge operators as determined in the example described above by FIGS. 7-9 in column 2 (labelled as “PA”). Columns 2-5 show Pauli weights for edge operators determined in a similar fashion for qubit layouts using different patterns. Column 6 shows Pauli weights for edge operators in connection with a Derby-Klassen (DK) fermion-to-qubit mapping, which is known in the prior art. The column labels specify a pattern of strings P and ancilla qubits A that is utilized in a horizontal row of qubits in the qubit layout (with each row being identical). The discussion is limited to cases where one mode per lattice site is considered, i.e. P′=P. With prior art mappings, the Pauli weights of the corresponding operators are usually higher. Even if similar or even lower Pauli weights corresponding to some of the determined operators could be achievable with a prior art method, these methods could not allow defining of at least some of the diagonal edge operators without violating a mode-independence criterion which is satisfied by the mappings of the present invention, i.e. the Pauli weight of the diagonal edge operators is independent of the number of modes per fermionic lattice site (at least considering square lattice qubit layouts). Even if such a criterion were not considered, the Pauli weights of the corresponding edge operators using prior art methods would not be lower than those that are achievable with the present invention, at least considering all determined edge operators.

TABLE 1
Pauli operator weights of edge operators
in one embodiment of the invention.

| Interaction | PA | PPA | PPAA | PAA | DK |
|---|---|---|---|---|---|
| 1^{st} horizontal | 3 | 2 | 2 | 4 | 3 |
| 2^{nd} horizontal | 3 | 3 | 4 | 4 | 3 |
| 1^{st} vertical | 4 | 4 | 4 | 4 | 3 |
| 2^{nd} vertical | 4 | 4 | 4 | 4 | 3 |
| 1^{st} diagonal | 4 | 4 | 5 | 5 | 3.5 |
| 2^{nd} diagonal | 4 | 4 | 5 | 5 | 3.5 |
| 3^{rd} diagonal | 4 | 5 | 5 | 5 | 3.5 |
| 4^{th} diagonal | 4 | 5 | 5 | 5 | 3.5 |

The qubit layout considered in the example of FIGS. 7-9, utilizing a P′A pattern that is at least partially repeated in each row of the qubit layout, may be advantageous due to the edge operators corresponding to each interaction acting on different, mutually exclusive, sets of qubits. This can be easily seen from the example of each of the separate figures of FIG. 9. The qubit operations depicted by each one of the separate figures can thus be carried out in parallel. This may reduce the circuit depth of an associated control sequence.

Further, as can be observed from Table 1 and FIG. 9, a maximum Pauli weight of the considered edge operators in column 2 is four. This is lower than the Pauli weights of edge operators that are obtainable with other qubit layouts, considering also the prior art. Thus, with a selected pattern of P′A, even further benefits may be gained, as circuit depth may be reduced as compared to other cases. In the case of one fermionic mode per lattice site, where P′=P, it may also be shown that the edge and vertex operators are similar to those as in the Verstraete-Cirac (VC) mapping known in the prior art, however being arranged in a different topology with a different connectivity. This is because VC considers a square grid of qubits where each qubit has an auxiliary qubit attached to it, which requires qubits with at least 5 connections, which would not be true with the 4-connected square grid of qubits that is usable with the present invention.

Yet, also a mapping utilizing a P′P′A pattern may be beneficial, as it may be the only mapping (considering also the prior art mappings) which has a qubit-to-mode ratio of 1.5 whilst utilizing all the qubits in at least a selected portion of a square lattice qubit layout and limiting all horizontal and vertical edge operators to a maximum Pauli weight of four.

If the fermionic Hamiltonian describes a system with two or more spin types within a fermionic lattice site, the modes Mᵢⱼₖ per each fermionic lattice site may be further assigned into a number of orbitals o, each orbital comprising a number of spins s, where Mᵢⱼₖ=o*s, where the physical qubits assigned with fermionic modes with the spins of one orbital are each separated by one physical qubit and where if the l indices of the physical qubits assigned with an orbital are odd, the fermionic modes associated with the physical qubits with the indices l are arranged so that increasing index l is associated with an increasing spin type s, whereas if the l indices of the physical qubits representing an orbital are even, the fermionic modes associated with the physical qubits with indices l are arranged so that increasing index l is associated with a decreasing spin type s.

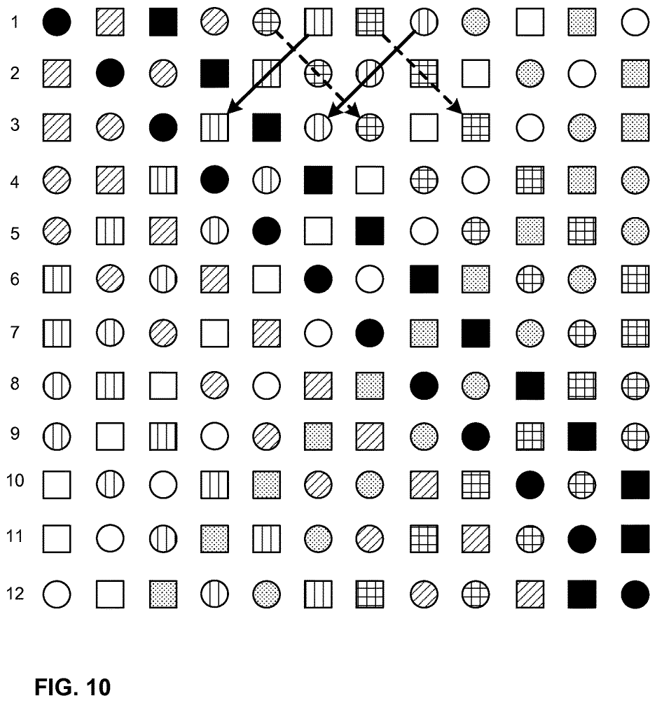

The assignment of fermionic modes to physical qubits considering one fermionic lattice site comprising a plurality of orbitals and two spin types is demonstrated in the example of FIG. 10. In FIG. 10, a chain of modes is shown in each row, with circles corresponding to first spin types (“up”) and squares corresponding to second spin types (“down”) (note that FIG. 10 depicts the fermionic modes and circles and squares in this figure are used to represent mode types and not physical and ancilla qubits). Different orbitals are depicted with different patterns of fills in the shapes, with FIG. 10 thus showing an example case of 6 orbitals. The numbered rows depict how the arrangement of modes is altered when using an fSWAP network of the type discussed in connection with FIG. 5D. The example of FIG. 10 thus shows 12 steps of an fSWAP network being employed. It may also be noted that FIG. 10 only shows a portion of the steps that would be carried out in an actual simulation involving an fSWAP network, where the network would comprise additional steps to ensure that all modes are shifted throughout the entire lattice arrangement so that each mode has resided at some point at both the right and left edge of the lattice arrangement.

As seen in FIG. 10, the spin modes of each orbital (which in this case may harbor two spin modes, one of each), may be arranged such that they are distance two apart (meaning that there is one spin mode of an adjacent orbital arranged between the spin modes of the same orbital). When the fermionic modes are arranged in this manner, as an fSWAP network is utilized, the modes may move in the arrangement of qubits such that every combination of two pairs of the same spin type, here “up” and “down” modes will be mutually adjacent at some point in the fSWAP network. The complete fSWAP network is cyclic and if only some interactions are required but not all of the interactions arising from the whole fSWAP network, it is possible to restrain the fSWAP to a subset of the fSWAP network that allows the required interaction, avoiding implementing the whole network if it is not necessary by saving some of the steps.

For modes of the same orbital (such as the pairs in the example) moving in a first direction as the fSWAP network is applied, the spin types may further be arranged such that first type spins are positioned to the second direction of the second type spin. Here, for pairs moving in the right-hand direction, spin “up” types are positioned to the left of “down” spin types and for pairs moving in the left-hand direction, spin “up” types are positioned to the right of spin “down” types. The spin types could, however, also be arranged the other way around. The solid arrows of FIG. 10 indicate a pair of modes that moves to a left hand direction, while dashed arrows indicate a pair of modes that moved to a right hand direction.

With the projection of fermionic modes to physical and ancilla qubits as discussed herein (repetition of arrangement of physical and ancilla qubits in each row of utilized qubits of a quantum device) and preferably taking into account native gates of the device, assignment of edge and vertex operators may then lead to determining of qubit operators corresponding to the fermionic operators that are required by the fermionic Hamiltonian that is to be considered.

It may also be noted that with the presently disclosed mappings, quartic terms that are required to simulate the Hubbard-Kanamori model may also be considered, as the quartic spin-exchange and pair-hopping terms always act on two pairs of spin modes within two orbitals. These groups of terms may be made adjacent within an fSWAP network by ensuring that pairs of spins of an orbital always move in the same direction. Considering an example of four orbitals, then this can be ensured by arranging the modes in the pattern: 1↑, 2↓, 1↓, 2↑, 3↑, 4↓, 3↓, 4↑. It may then be seen that any two spin modes of an orbital will at every step of an fSWAP network be at most one qubit apart.

The thus obtained control sequence comprising qubit operators will then be strings of Pauli operators, which may be utilized to implement an evolution operator of a fermionic Hamiltonian on the quantum device as a quantum circuit. The exponential containing the fermionic Hamiltonian may be Trotterized and the exponential according to each term may be implemented, as will be well known to the skilled person. A suitable fSWAP network may be selected to achieve a desired or optimal (lowest) circuit depth. With the mapping according to the present invention, fSWAP networks may be used to obtain a control sequence corresponding to a quantum circuit that is lower in depth than a control sequence determined by prior art methods (prior art mappings, specifically) for the same fermionic system.

As will be known to the skilled person, the determined control sequence may be implemented on a quantum device to determine at least one characteristic of a fermionic system, such as a ground state energy. Determining of a characteristic may also be referred to as simulating the fermionic system. The method of determining at least one characteristic of the fermionic system may comprise determining or obtaining or receiving a fermionic Hamiltonian, where the at least one characteristic of the system is characterized by the Hamiltonian, determining a control sequence according to the method described herein, implementing the determined control sequence on a quantum device, and applying one or more measurement gates to determine the characteristic of the system.

1. A computer-implemented method for determining a control sequence for performing a series of qubit interactions on a plurality of qubits on a quantum device to simulate a fermionic Hamiltonian H expressible as a sum of one or more tensor products of Pauli matrices,
wherein the plurality of qubits on the quantum device is arranged into a two-dimensional square lattice qubit layout, where each qubit is arranged to interact with up to four neighboring qubits, and
wherein the method comprises:
receiving input parameters of the fermionic Hamiltonian to be simulated, the parameters comprising at least:
a number of fermionic lattice sites L,
a number of fermionic modes M in the fermionic lattice, and
fermionic operator corresponding to interactions between the fermionic modes M,
projecting the fermionic lattice to the qubit layout of the quantum device such that every fermionic mode is assigned to a qubit of the quantum device, wherein said qubit is referred to as a physical qubit P, wherein the projection between the fermionic modes and the physical qubits P is one to one, and wherein a plurality of further qubits of the quantum device are referred to as ancilla qubits A, said ancilla qubits A not being assigned with any fermionic mode,
wherein the physical qubits P and the ancilla qubits A are arranged onto horizontal single lines of the two-dimensional square lattice, each horizontal single line comprising at least one string P′ and at least one ancilla qubit A, wherein each string P′ comprises one or more physical qubits P,
wherein the arrangement of physical qubits P and ancilla qubits A in each single horizontal line of the qubit layout is the same,
associating each physical qubit P with at least one edge operator E and one vertex operator V
mapping each fermionic operator to a qubit operator based on the edge operators E and vertex operators V,
determining a control sequence of qubit interactions, said control sequence comprising at least the qubit operators determined by the mapping.

2. The method of claim 1, wherein each qubit operator comprises a product of vertex operators V, wherein each of the vertex operators V operates on at least one of the physical qubits P assigned to the fermionic modes of the fermionic operator.

3. The method of claim 1, wherein each qubit operator comprises a product of at least one of the vertex operators V with one of the edge operators E, wherein each of the vertex and edge operators in the product operates on at least one of the physical qubits P assigned to the fermionic modes of the fermionic operator.

4. The method of claim 1, wherein associating each physical qubit P with at least one edge operator E and one vertex operator V comprises determining edge operators E and vertex operators V such that edge and vertex operators acting on the same physical qubits P pairwise anti-commute.

5. The method of claim 1, wherein associating each physical qubit P with at least one edge operator E and one vertex operator V comprises:
associating each physical qubit P with a vertex operator Vₚ, wherein Vₚ is a Pauli operator of first type, selected from Pauli operator types X, Y and Z, acting on physical qubit p,
for any pair of physical qubits p and q, which in the horizontal dimension are either direct neighbors without any physical or ancilla qubits between them, or are separated by one or two ancilla qubits, define a horizontal edge operator
$${E}_{pq}^{H} ,$$
associated with said qubits, wherein
$${E}_{pq}^{H}$$
is a product of a number of Pauli operators comprising:
at least two Pauli operators, each of second or third type, selected from Pauli operator types X, Y, and Z, and acting on qubits p and q respectively, and
if any ancilla qubits are present between the physical qubits p and q along the horizontal dimension, additional Pauli operators, each of first type, acting on each of said, if any present, ancilla qubits,
wherein when two horizontal edge operators act on the same qubit q, if the first of the two horizontal edge operators
$${E}_{pq}^{H 1}$$
acts on the qubit q with a Pauli operator of second type, then the second of the two horizontal edge operators
$${E}_{pq}^{H 2}$$
acts on the qubit q with a Pauli operator of third type and vice versa,
for any pair of physical qubits p and q, where said physical qubits p and q are direct neighbors in the vertical dimension, and where said pair of physical qubits is adjacent to a pair of ancilla qubits a and b, where said ancilla qubits a and b are direct neighbors in the vertical dimension, said ancilla qubits a and b are arranged adjacent to the qubits p and q respectively, define a vertical edge operator
$${E}_{pq}^{V} ,$$
associated with said qubits p, q, a, b, wherein
$${E}_{pq}^{V}$$
is a product of four Pauli operators, each of second or third type and each acting on one of the qubits p, q, a, b such that each of the four Pauli operators acts on a different qubit, wherein
the Pauli operators acting on the ancilla qubits a and b are of different type,
the Pauli operator acting on the physical qubit p is of the same type as the Pauli operator acting on the physical qubit q and forming a part of the horizontal edge operator acting on at least the physical qubit p and the ancilla qubit a, and similarly the Pauli operator acting on the physical qubit q is of the same type as the Pauli operator acting on the physical qubit p and forming a part of the horizontal edge operator acting at least on the physical qubit q and the ancilla qubit b,
a vertical edge operator is referred to as a first vertical edge operator
$${E}_{pq}^{V 1}$$
when the ancilla qubits a and b are arranged on a first side of the physical qubits p and q respectively along the horizontal dimension, or as a second vertical edge operator
$${E}_{pq}^{V 2}$$
when the ancilla qubits a and b are arranged on a second side of the physical qubits p and q along the horizontal dimension,
wherein when two vertical edge operators act on the same ancilla qubit, if one of the two vertical edge operators acts on said ancilla qubit with a Pauli operator of second type, then the other of the two vertical edge operators acts on said ancilla qubit with a Pauli operator of third type and vice versa.

6. The method of claim 1, wherein a single horizontal line of qubits comprises at most two consecutive ancilla qubits A.

7. The method of claim 1, wherein the step of receiving parameters of the fermionic Hamiltonian to be simulated comprises obtaining a number of fermionic modes in each of the fermionic lattice sites, a number of fermionic lattice sites in a first dimension L₁, a number of fermionic lattice sites in a second dimension L₂, and a number of fermionic lattice sites in a third dimension L₃, where a total number of fermionic lattice sites is L=L₁L₂L₃, a fermionic lattice site being identified by indices i, j, k, indicating fermionic lattice site position along the respective dimensions, where i=[1, L₁], j=[1, L₂], k=[1, L₃], and the number of fermionic modes in each of the fermionic lattice sites identified by indices i, j, k being labelled as Mᵢⱼₖ such that total number of fermionic modes in the fermionic lattice is
$$M = {\sum }_{i = 1}^{{L}_{1}} {\sum }_{j = 1}^{{L}_{2}} {\sum }_{k = 1}^{{L}_{3}} {M}_{ijk}$$
and wherein each fermionic mode of the fermionic Hamiltonian is identified by four indices i, j, k, l, where l=[1, Mᵢⱼₖ], further wherein the step of projecting the fermionic lattice onto the square lattice qubit layout of the quantum device comprises assigning each fermionic mode, identified by the four indices i, j, k, l, of the fermionic lattice to a physical qubit Pᵢⱼₖₗ of the quantum device, where the indices of each physical qubit identify the fermionic mode with which the physical qubit is assigned.

8. The method of claim 7, wherein the step of projecting the fermionic lattice onto the qubit layout of the quantum device comprises arranging the physical qubits Pᵢⱼₖₗ each assigned with a fermionic mode identified by the indices i, j, k, l, within the qubit layout such that:
each single horizontal line of the qubit layout comprises L₁ strings P′, each string denoted as P′ᵢⱼ to indicate that the string comprises a number of physical qubits Pᵢⱼₖₗ assigned with fermionic modes associated with fermionic lattice sites with position indices i and j, where the number of physical qubits within a string P′ᵢⱼ is equal to
$${\sum }_{k = 1}^{{L}_{3}} {M}_{ijk} ,$$
each physical qubit with a lower index i is arranged, in the horizontal dimension, before any physical qubit with a higher index i,
the number of single horizontal lines in the qubit layout that is participating in the projecting is equivalent to L₂, and each physical qubit with a lower index j is arranged, in the vertical dimension, before any physical qubit with a higher index j, and
physical qubits within each string P′ are associated with varying indices k and l and arranging their respective order depending on the fermionic interactions.

9. The method of claim 8, wherein the method comprises arranging physical qubits within any string P′ in the horizontal dimension such that the order of physical qubits with indices k and l is opposite in the consecutive string P′.

10. The method of claim 1, wherein if one or more of the fermionic lattice sites comprises more than one mode associated with said lattice site, the control sequence further comprises one or more fSWAP operators to rearrange fermionic modes assigned to physical qubits by the projecting, to implement interactions between fermionic modes that are comprised in the Hamiltonian, for which interactions a qubit operator has not been applied before said rearranging.

11. The method of claim 1, further wherein if the fermionic Hamiltonian describes a system with two or more spin types within a fermionic lattice site, the modes Mᵢⱼₖ per each fermionic lattice site are further assigned into a number of orbitals o, each orbital comprising a number of spins s, where Mᵢⱼₖ=0*s, where the physical qubits assigned with fermionic modes with the spins of one orbital are each separated by one physical qubit.

12. The method of claim 1, wherein the physical qubits P in a single horizontal line of qubits are grouped into pairs of physical qubits, said pairs being alternatingly labelled as even or odd, and neighboring pairs of such even or odd labelled qubit pairs share a physical qubit P, wherein the step of associating each physical qubit P with at least one edge operator E comprises:
for each even pair of physical qubits p and q, define an even horizontal edge operator
$${E}_{pq}^{H 1}$$
associated with said qubits, wherein
if q and p are direct neighbors not separated by an ancilla qubit,
$${E}_{pq}^{H 1}$$
is a product of two Pauli operators of second type acting on physical qubits p and q, respectively, optionally wherein
$${E}_{pq}^{H 1} = {X}_{p} {X}_{q} ,$$
if p and q are separated by one ancilla qubit a,
$${E}_{pq}^{H 1}$$
is a product of a Pauli operator of second type acting on physical qubit p, a Pauli operator of first type acting on ancilla qubit a, and a Pauli operator of second type acting on physical qubit p, optionally wherein
$${E}_{pq}^{H 1} = {X}_{p} {Z}_{a} {X}_{q} ,$$
if p and q are separated by two ancilla qubits a and b,
$${E}_{pq}^{H 1}$$
is a product of a Pauli operator of second type acting on physical qubit p, a Pauli operator of first type acting on ancilla qubit a, a Pauli operator of first type acting on ancilla qubit b, and a Pauli operator of second type acting on physical qubit p, optionally wherein
$${E}_{pq}^{H 1} = {X}_{p} {Z}_{a} {Z}_{b} {X}_{q} ,$$
for each off pair of physical qubits p and q, define an odd horizontal edge operator
$${E}_{pq}^{H 2}$$
associated with said qubits, wherein
if p and q are direct neighbors not separated by an ancilla qubit,
$${E}_{pq}^{H 2}$$
is a product of two Pauli operators of third type acting on physical qubits p and q, respectively, optionally wherein
$${E}_{pq}^{H 2} = {Y}_{p} {Y}_{q} ,$$
if p and q are separated by one ancilla qubit a,
$${E}_{pq}^{H 2}$$
is a product of a Pauli operator of third type acting on physical qubit p, a Pauli operator of first type acting on ancilla qubit a, and a Pauli operator of third type acting on physical qubit p, optionally wherein
$${E}_{pq}^{H 2} = {Y}_{p} {Z}_{a} {Y}_{q} ,$$
if p and q are separated by two ancilla qubits a and b,
$${E}_{pq}^{H 2}$$
is a product of a Pauli operator of third type acting on physical qubit p, a Pauli operator of first type acting on ancilla qubit a, a Pauli operator of first type acting on ancilla qubit b, and a Pauli operator of third type acting on physical qubit p, optionally wherein
$${E}_{pq}^{H 2} = {Y}_{p} {Z}_{a} {Z}_{b} {Y}_{q} ,$$
for each pair of physical qubits p and q, which in the vertical dimension are direct neighbors without any physical or ancilla qubits between them, define a vertical edge operator
$${E}_{pq}^{V}$$
associated with said qubits, wherein
if ancilla qubits a and b are direct neighbors of p and q in the horizontal dimension in a first direction, with p and q having no other ancilla qubits as direct horizontal neighbors, and wherein a and b are associated with even horizontal edge operators,
$${E}_{pq}^{V}$$
is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein
$${E}_{pq}^{V} = {X}_{p} {X}_{a} {Y}_{b} {X}_{q} ,$$
if ancilla qubits a and b are direct neighbors of p and q in the horizontal dimension in the first direction L₁, with p and q having no other ancilla qubits as direct horizontal neighbors, and wherein a and b are associated with odd horizontal edge operators,
$${E}_{pq}^{V}$$
is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein
$${E}_{pq}^{V} = {Y}_{p} {X}_{a} {Y}_{b} {Y}_{q} ,$$
if ancilla qubits a and b are direct neighbors of p and q in the horizontal dimension in a second direction L₂, with p and q having no other ancilla qubits as direct horizontal neighbors, and wherein a and b are associated with even horizontal edge operators,
$${E}_{pq}^{V}$$
is a product of a Pauli operator of the second type acting on physical qubit p, a Pauli operator of the third type acting on ancilla qubit a, a Pauli operator of the second type acting on ancilla qubit b, and a Pauli operator of the second type acting on physical qubit q, optionally wherein
$${E}_{pq}^{V} = {X}_{p} {Y}_{a} {X}_{b} {X}_{q} ,$$
if ancilla qubits a and b are direct neighbors of p and q in the horizontal dimension in the second direction L₂, with p and q having no other direct ancilla qubits as horizontal neighbors, and wherein a and b are associated with odd horizontal edge operators,
$${E}_{pq}^{V}$$
is a product of a Pauli operator of the third type acting on physical qubit p, a Pauli operator of the third type acting on ancilla qubit a, a Pauli operator of the second type acting on ancilla qubit b, and a Pauli operator of the third type acting on physical qubit q, optionally wherein
$${E}_{pq}^{V} = {Y}_{p} {Y}_{a} {X}_{b} {Y}_{q} ,$$
if p and q are direct neighbors of ancilla qubits a and b in the horizontal dimension in the first direction L₁, with ancilla qubits c and d as direct neighbors in the second direction L₂,
for the first direction L₁:
$${E}_{pq}^{V}$$
is a product of a Pauli operator of the second type acting on physical qubit p, a Pauli operator of the second type acting on ancilla qubit a, a Pauli operator of the third type acting on ancilla qubit b, and a Pauli operator of the second type acting on physical qubit q, optionally wherein
$${E}_{pq}^{V} = {X}_{p} {X}_{a} {Y}_{b} {X}_{q} , or {E}_{pq}^{V}$$
is a product of a Pauli operator of the third type acting on physical qubit p, a Pauli operator of the second type acting on ancilla qubit a, a Pauli operator of the third type acting on ancilla qubit b, and a Pauli operator of the third type acting on physical qubit q, optionally wherein
$${E}_{pq}^{V} = {Y}_{P} {X}_{a} {Y}_{a} {Y}_{q} ,$$
for a second direction L₂:
$${E}_{pq}^{V}$$
is a product of a Pauli operator of the second type acting on physical qubit p, a Pauli operator of the third type acting on ancilla qubit c, a Pauli operator of the second type acting on ancilla qubit d, and a Pauli operator of the second type acting on physical qubit q, optionally wherein
$${E}_{pq}^{V} = {X}_{p} {X}_{c} {Y}_{d} {X}_{q} , or {E}_{pq}^{V}$$
is a product or a Pauli operator of the third type acting on physical qubit p, a Pauli operator of the third type acting on ancilla qubit c, a Pauli operator of the second type acting on ancilla qubit d, and a Pauli operator of the third type acting on physical qubit q, optionally wherein
$${E}_{pq}^{V} = {Y}_{P} {Y}_{c} {X}_{d} {Y}_{q} .$$

13. The method of claim 1, wherein qubits are arranged into a pattern, said pattern being repeated successively within the single horizontal line of qubits, wherein the pattern is selected from the group of P′A, P′P′A, P′P′AA, and P′AA.

14. The method of claim 13, wherein the pattern is selected by determining maximum Pauli weights of edge operators E associated with at least two patterns, and selecting a pattern that is associated with a lowest maximum Pauli weight.

15. The method of claim 13, wherein the pattern is selected by determining a circuit depth of a control sequence separately associated with at least two patterns, and selecting a pattern that is associated with a lowest circuit depth.

16. The method of claim 13, wherein the pattern is selected by determining a number and/or type of gates comprised in a control sequence separately associated with at least two patterns, and selecting a pattern that is associated with a lowest number of gates and/or a pattern that is associated with selected types of gates and/or a pattern that is associated with a selected qubit-to-mode ratio.

17. A computer program product comprising program code adapted to execute the method of claim 1 when run on a computer.

18. A quantum circuit comprising a sequence of qubit interactions determined according to the method of claim 1, executable on a quantum device for simulating a fermionic Hamiltonian.

19. (canceled)
